(19) United States
(12) Patent Application Publication
(10) Pub. No.: US 2008/0081533 A1
(43) Pub. Date: Apr. 3, 2008

(54) METHOD OF MANUFACTURING ANODE PANEL FOR FLAT-PANEL DISPLAY DEVICE, METHOD OF MANUFACTURING FLAT-PANEL DISPLAY DEVICE, ANODE PANEL FOR FLAT-PANEL DISPLAY DEVICE, AND FLAT-PANEL DISPLAY DEVICE

(75) Inventors: Yoshimitsu KATO, Kanagawa (JP); Yukinobu Iguchi, Gifu (JP); Satoshi Okanan, Gifu (JP); Yasuhito Hatano, Aichi (JP); Keiji Honda, Aichi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/872,404

(22) Filed: Oct. 15, 2007

Related U.S. Application Data
(62) Division of application No. 11/472,433, filed on Jun. 22, 2006.

(30) Foreign Application Priority Data
Jun. 27, 2005 (JP) 2005-186555

(51) Int. Cl. H01J 9/02

(52) U.S. Cl. 445/24

(57) ABSTRACT

A method of manufacturing an anode panel, the anode panel including a substrate, unit phosphor regions, lattice-shaped barrier ribs, anode electrode units, and a resistor layer for electrically connecting the anode electrode units to each other, the method including the steps of: obtaining the anode electrode units by forming the barrier ribs and the unit phosphor regions on the substrate, next forming a conductive material layer on an entire surface, and then removing parts of the conductive material layer which parts are situated on barrier rib top surfaces; and forming the resistor layer; wherein a step of removing the parts of the conductive material layer which parts are situated on the barrier rib top surfaces includes a step of attaching a peeling layer to the parts of the conductive material layer which parts are situated on the barrier rib top surfaces and then mechanically peeling off the peeling layer.

### CROSS REFERENCES TO RELATED APPLICATIONS

This application is a division of and is based upon and claims the benefit of priority under 35 U.S.C. §120 for U.S. Ser. No. 11/472,433, filed Jun. 22, 2006, and claims the benefit of priority under 35 U.S.C. § 119 from Japanese Patent Application No. JP 2005-186555, filed Jun. 27, 2005, the entire contents of each which are incorporated herein by reference.

### BACKGROUND OF THE INVENTION

1. Field of the Invention

The present invention relates to a method of manufacturing an anode panel for a flat-panel display device, a method of manufacturing a flat-panel display device, an anode panel for a flat-panel display device, and a flat-panel display device.

2. Description of the Related Art

As image display devices superceding currently mainstream cathode ray tubes (CRTs), various flat-type (flat-panel) display devices are studied. Such flat-panel display devices include liquid crystal display devices (LCDs), electroluminescence display devices (ELDs), and plasma display devices (PDPs). In addition, the development of a flat-panel display device incorporating a cathode panel having electron emission elements is under way. Known as electron emission elements are cold cathode field electron emission elements, metal-insulator-metal elements (referred to also as MIM devices), and surface conduction type electron emission elements. A flat-panel display device incorporating a cathode panel having electron emission elements formed of these cold cathode electron sources is drawing attention because of high resolution, high-luminance color display, and low power consumption.

FIG. 23 is a schematic plan view of an anode electrode in a cold cathode field electron emission display device (hereinafter abbreviated simply to a display device) disclosed in a second example of an invention of Japanese Patent Laid-Open No. 2004-158232. FIGS. 24A, 24B, and 24C are schematic partial end views of an anode panel AP, taken along an arrow line A-A, an arrow line B-B, and an arrow line C-C, respectively, of FIG. 23. FIG. 25 is a schematic partial end view of this display device. FIG. 26 is a schematic partial perspective view of the anode panel AP and a cathode panel CP. Incidentally, in FIG. 26, for the simplification of the drawing, anode electrode units are not shown, and barrier ribs are not shown.

This display device is formed by bonding the cathode panel CP including a plurality of cold cathode field electron emission elements (hereinafter abbreviated to field emission elements) and the anode panel AP to each other at peripheral parts thereof.

A field emission element shown in FIG. 25 is a so-called Spindt-type field emission element having a conical-shaped electron emission part. This field emission element includes: a cathode electrode 11 formed on a support 10; an insulating layer 12 formed on the support 10 and the cathode electrode 11; a gate electrode 13 formed on the insulating layer 12; an opening part 14 formed in the gate electrode 13 and the insulating layer 12 (a first opening part 14A formed in the gate electrode 13 and a second opening part 14B formed in the insulating layer 12); and a conical-shaped electron emission part 15 formed on the cathode electrode 11 situated at a bottom part of the second opening part 14B. Generally, the cathode electrode 11 and the gate electrode 13 are formed in the form of a stripe each in directions in which the projection images of these two electrodes are orthogonal to each other. Generally, a plurality of field emission elements are provided in a region where the projection images of the two electrodes overlap each other (which region corresponds to one subpixel, and will hereinafter be referred to as an overlap region or an electron emission region). Further, generally, such electron emission regions are arranged in the form of a two-dimensional matrix within an effective region (a region functioning as an actual display part) of the cathode panel CP.

The anode panel AP includes: a substrate 120; unit phosphor regions 121 formed on the substrate 120 and having a predetermined pattern; an anode electrode 130 formed on the unit phosphor regions 121; and a feeding section 140 (not shown in FIG. 25). The anode electrode 130, as a whole, has a shape covering the rectangular effective region. The anode electrode 130 is formed of an aluminum thin film, for example. A light absorbing layer (black matrix) 122 is formed between a unit phosphor region 121 and a unit phosphor region 121 on the substrate 120. Barrier ribs 123 are formed on the light absorbing layer 122. The plan shape of the barrier ribs 123 is a lattice shape (grid shape), and has a shape surrounding one subpixel (unit phosphor region).

One subpixel in this case includes a group of field emission elements provided in an overlap region of the cathode electrode 11 and the gate electrode 13 on the cathode panel side, and a unit phosphor region 121 on the anode panel side which region faces the group of these field emission elements (one red light emitting unit phosphor region, one green light emitting unit phosphor region, or one blue light emitting unit phosphor region). Such subpixels on the order of hundreds of thousands to millions, for example, are arranged in the effective region. One pixel is composed of three subpixels.

The anode electrode 130 is composed of a set of anode electrode units 131 covering the unit phosphor regions 121. Gaps 132A and 132B are provided between the anode electrode units 131. The gap 132A is provided at a part of the substrate 120 at which part the unit phosphor regions 121 are not formed. The gap 132B is formed so as to be situated at a top surface of the barrier rib 123, or so as to extend astride the barrier rib 123. A resistor layer 133 is formed between an anode electrode unit 131 and an anode electrode unit 131. More specifically, the resistor layer 133 is formed so as to cross over the gaps 132A and 132B and extend between adjacent anode electrode units 131. The resistor layer 133 is composed of a resistor thin film made of SiC, for example, and is formed by a sputtering method.

The anode electrode unit 131 has a size that prevents the anode electrode unit 131 from being locally vaporized by energy generated by a discharge occurring between the anode electrode unit 131 and the field emission elements (more specifically the gate electrode 13 or the cathode electrode 11) (more specifically a size that prevents a part of the anode electrode unit 131 which part corresponds to one subpixel from being vaporized by energy generated by a discharge occurring between the anode electrode unit 131 and the gate electrode 13 or the cathode electrode 11). Incidentally, FIG. 23 shows 4×4 anode electrode units 131 to simplify the drawing, and the schematic partial sectional views show one anode electrode unit 131 covering a plurality of unit phosphor regions. In practice, however, the size of an anode electrode unit 131 corresponds to for example a size covering a unit phosphor region, that is, one subpixel.

An anode electrode unit 131A forming one side of the anode electrode 130 is connected to an anode electrode control circuit 53 via a feeding section 140. A resistor R₀ for preventing overcurrent and electric discharge is generally disposed between the anode electrode control circuit 53 and the feeding section 140. The feeding section 140 is formed by feeding section units 141 connected in series with each other via a feeding section resistor layer 143. A gap 142A is provided between a feeding section unit 141 and a feeding section unit 141. The feeding section resistor layer 143 is formed on the gap 142A so as to extend between the feeding section unit 141 and the feeding section unit 141. The feeding section unit 141 is also formed of an aluminum thin film, for example. A gap 142B is provided between the anode electrode unit 131A forming one side of the anode electrode 130 and the feeding section unit 141. The anode electrode unit 131A forming one side of the anode electrode 130 and the feeding section unit 141 are connected to each other via a resistance member 134. The resistance member 134 is formed on the gap 142B on the basis of a CVD method so as to extend between the anode electrode unit 131 and the feeding section unit 141.

In the display device disclosed in Japanese Patent Laid-Open No. 2004-158232, the anode electrode is formed so as to be divided into anode electrode units 131 having a smaller area instead of being formed over substantially the entire surface of the effective region, capacitance between the anode electrode units 131 and the cold cathode field electron emission elements can be decreased. As a result, it is possible to reduce occurrence of discharge, and effectively reduce occurrence of damage caused by the discharge to the anode electrode and cold cathode field electron emission elements. Further, since the feeding section 140 is formed by a plurality of feeding section units 141, it is possible to reduce a capacitance formed between the feeding section 140 and the field emission elements forming the cathode panel CP, and effectively reduce occurrence of damage to the feeding section 140 and cold cathode field electron emission elements which damage is caused by discharge between the feeding section 140 and the cold cathode field electron emission elements. In addition, since the resistor layer 133 is formed between an anode electrode unit 131 and an anode electrode unit 131, occurrence of discharge between the anode electrode units 131 can be surely reduced.

### SUMMARY OF THE INVENTION

Thus, the display device disclosed in Japanese Patent Laid-Open No. 2004-158232 can reduce the occurrence of discharge. The formation of the anode electrode units 131 is performed by forming a conductive material layer, forming a resist layer on the basis of a lithography technique, and patterning the conductive material layer by an etching technique using the resist layer. However, damage can be caused to phosphor regions by an etchant when the conductive material layer is patterned, and damage can be caused to phosphor regions by a peeling solution when the resist layer is peeled off by the peeling solution after the patterning of the conductive material layer. Such phenomena lower image quality of the display device.

While the feeding section 140 is formed by the feeding section units 141 connected in series with each other via the feeding section resistor layer 143, there is a strong demand for further reduction of the discharge between the feeding section 140 and cold cathode field electron emission elements.

Accordingly, it is desirable to provide a method of manufacturing an anode panel for a flat-panel display device and a method of manufacturing a flat-panel display device that eliminate a fear of damage being caused to phosphor regions when anode electrode units are formed. It is also desirable to provide an anode panel for a flat-panel display device and a flat-panel display device having a structure that can further reduce discharge between a feeding section and cold cathode field electron emission elements, and methods of manufacturing the anode panel for the flat-panel display device and the flat-panel display device.

According to a first embodiment of the present invention, there is provided a method of manufacturing an anode panel for a flat-panel display device, the anode panel for the flat-panel display device including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, and (E) a resistor layer for electrically connecting adjacent anode electrode units to each other, the method including: a step of obtaining the anode electrode unit formed so as to extend from on each unit phosphor region to on the barrier ribs by forming the lattice-shaped barrier ribs on the substrate, then forming the unit phosphor regions on parts of the substrate which parts are surrounded by the barrier ribs, next forming the conductive material layer on an entire surface, and then removing parts of the conductive material layer which parts are situated on barrier rib top surfaces; and a step of forming the resistor layer for electrically connecting adjacent anode electrode units to each other after forming the lattice-shaped barrier ribs on the substrate, after forming the unit phosphor regions on the parts of the substrate which parts are surrounded by the barrier ribs, or after removing the parts of the conductive material layer which parts are situated on the barrier rib top surfaces; wherein a step of removing the parts of the conductive material layer which parts are situated on the barrier rib top surfaces includes a step of bonding a peeling member to the parts of the conductive material layer which parts are situated on the barrier rib top surfaces and then mechanically peeling off the peeling member.

In addition, according to the first embodiment of the present invention, there is provided a method of manufacturing a flat-panel display device, the flat-panel display device being formed by joining an anode panel and a cathode panel having a plurality of electron emission elements to each other at peripheral parts of the anode panel and the cathode panel, the anode panel including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, and (E) a resistor layer for electrically connecting adjacent anode electrode units to each other, the anode panel being manufactured by the manufacturing method including: a step of obtaining the anode electrode unit formed so as to extend from on each unit phosphor region to on the barrier ribs by forming the lattice-shaped barrier ribs on the substrate, then forming the unit phosphor regions on parts of the substrate which parts are surrounded by the barrier ribs, next forming the conductive material layer on an entire surface, and then removing parts of the conductive material layer which parts are situated on barrier rib top surfaces; and a step of forming the resistor layer for electrically connecting adjacent anode electrode units to each other after forming the lattice-shaped barrier ribs on the substrate, after forming the unit phosphor regions on the parts of the substrate which parts are surrounded by the barrier ribs, or after removing the parts of the conductive material layer which parts are situated on the barrier rib top surfaces; wherein a step of removing the parts of the conductive material layer which parts are situated on the barrier rib top surfaces includes a step of bonding a peeling member to the parts of the conductive material layer which parts are situated on the barrier rib top surfaces and then mechanically peeling off the peeling member.

According to a second embodiment of the present invention, there is provided a method of manufacturing an anode panel for a flat-panel display device, the anode panel for the flat-panel display device including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, and (E) a resistor layer for electrically connecting adjacent anode electrode units to each other, the method including: a step of obtaining the anode electrode unit formed so as to extend from on each unit phosphor region to on the barrier ribs by forming the lattice-shaped barrier ribs on the substrate, then forming the unit phosphor regions on parts of the substrate which parts are surrounded by the barrier ribs, next forming the conductive material layer on an entire surface, and then removing parts of the conductive material layer which parts are situated on barrier rib top surfaces; and a step of forming the resistor layer for electrically connecting adjacent anode electrode units to each other after forming the lattice-shaped barrier ribs on the substrate, after forming the unit phosphor regions on the parts of the substrate which parts are surrounded by the barrier ribs, or after removing the parts of the conductive material layer which parts are situated on the barrier rib top surfaces; wherein a step of removing the parts of the conductive material layer which parts are situated on the barrier rib top surfaces includes a step of applying an etchant to the parts of the conductive material layer which parts are situated on the barrier rib top surfaces.

In addition, according to the second embodiment of the present invention, there is provided a method of manufacturing a flat-panel display device, the flat-panel display device being formed by joining an anode panel and a cathode panel having a plurality of electron emission elements to each other at peripheral parts of the anode panel and the cathode panel, the anode panel including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, and (E) a resistor layer for electrically connecting adjacent anode electrode units to each other, the anode panel being manufactured by the manufacturing method including: a step of obtaining the anode electrode unit formed so as to extend from on each unit phosphor region to on the barrier ribs by forming the lattice-shaped barrier ribs on the substrate, then forming the unit phosphor regions on parts of the substrate which parts are surrounded by the barrier ribs, next forming the conductive material layer on an entire surface, and then removing parts of the conductive material layer which parts are situated on barrier rib top surfaces; and a step of forming the resistor layer for electrically connecting adjacent anode electrode units to each other after forming the lattice-shaped barrier ribs on the substrate, after forming the unit phosphor regions on the parts of the substrate which parts are surrounded by the barrier ribs, or after removing the parts of the conductive material layer which parts are situated on the barrier rib top surfaces; wherein a step of removing the parts of the conductive material layer which parts are situated on the barrier rib top surfaces includes a step of applying an etchant to the parts of the conductive material layer which parts are situated on the barrier rib top surfaces.

In the method of manufacturing the anode panel for the flat-panel display device or the method of manufacturing the flat-panel display device according to the first embodiment or the second embodiment of the present invention, the anode electrode unit is formed so as to extend from on each unit phosphor region to on the barrier ribs. Specifically, the anode electrode unit can be formed so as to extend from on each unit phosphor region to on side surfaces of the barrier ribs. Incidentally, the anode electrode unit may be formed so as to extend from on each unit phosphor region to halfway points on the side surfaces of the barrier ribs. Forms in which the resistor layer is formed include a form in which the resistor layer is formed on the barrier rib top surfaces, a form in which the resistor layer is formed so as to extend from on the barrier rib top surfaces to on barrier rib side surfaces, a form in which the resistor layer is formed continuously on the barrier ribs and on the substrate, and a form in which the resistor layer is formed continuously on the barrier ribs and on the unit phosphor regions.

The method of manufacturing the anode panel for the flat-panel display device or the method of manufacturing the flat-panel display device according to the first embodiment or the second embodiment of the present invention can further include a step of forming a resin layer on the barrier rib top surfaces and on the unit phosphor regions before forming the conductive material layer on the entire surface, wherein the resin layer can be removed by performing heat treatment after forming the conductive material layer on the entire surface or after removing the parts of the conductive material layer which parts are situated on the barrier rib top surfaces. When such a resin layer is formed, the resin layer functions to protect the unit phosphor regions in various steps in manufacturing the anode panel. It is therefore possible to reliably prevent damage from being caused to the unit phosphor regions, and make the anode electrode units obtain a mirror surface.

Table 1 below collectively shows orders of the step of forming the lattice-shaped barrier ribs on the substrate [barrier rib forming step], the step of forming the unit phosphor regions on the parts of the substrate which parts are surrounded by the barrier ribs [phosphor region forming step], the step of forming the conductive material layer on the entire surface [conductive material layer forming step], the step of removing the parts of the conductive material layer which parts are situated on the barrier rib top surfaces [conductive material layer partial removal step], the step of forming the resistor layer for electrically connecting adjacent anode electrode units to each other [resistor layer forming step], the step of forming the resin layer on the barrier rib top surfaces and on the unit phosphor regions [resin layer forming step], and the step of removing the resin layer by performing heat treatment [resin layer removing step] in the method of manufacturing the anode panel for the flat-panel display device or the method of manufacturing the flat-panel display device according to the first embodiment or the second embodiment of the present invention.

TABLE 1

| | | | | | | | | | |
|---|---|---|---|---|---|---|---|---|---|
| Barrier rib | 1 | 1 | 1 | 1 | 1 | 1 | 1 | 1 | 1 |
| forming step | | | | | | | | | |
| Phosphor region | 2 | 2 | 2 | 2 | 3 | 3 | 2 | 2 | 2 |
| forming step | | | | | | | | | |
| Conductive | 4 | 4 | 5 | 5 | 5 | 5 | 4 | 5 | 5 |
| material layer | | | | | | | | | |
| forming step | | | | | | | | | |
| Conductive | 5 | 5 | 6 | 7 | 6 | 7 | 6 | 7 | 6 |
| material layer | | | | | | | | | |
| partial removal | | | | | | | | | |
| step | | | | | | | | | |
| Resistor layer | 7 | 6 | 4 | 4 | 2 | 2 | 7 | 3 | 3 |
| forming step | | | | | | | | | |
| Resin layer | 3 | 3 | 3 | 3 | 4 | 4 | 3 | 4 | 4 |
| forming step | | | | | | | | | |
| Resin layer | 6 | 7 | 7 | 6 | 7 | 6 | 5 | 6 | 7 |
| removing step | | | | | | | | | |

In the method of manufacturing the anode panel for the flat-panel display device or the method of manufacturing the flat-panel display device according to the first embodiment of the present invention including the above-described preferred constitutions (these manufacturing methods may hereinafter be abbreviated collectively to a manufacturing method according to the first embodiment of the present invention), it is desirable that the peeling member include a cohesive layer or an adhesive layer, and a retaining film (supporting film) for retaining the cohesive layer or the adhesive layer, and that a method of attaching the peeling member to the parts of the conductive material layer which parts are situated on the barrier rib top surfaces be a method of pressure-bonding the cohesive layer or the adhesive layer forming the peeling member to the parts of the conductive material layer which parts are situated on the barrier rib top surfaces. Alternatively, in this case, it is desirable that the plan shape of a part of the barrier ribs which part surrounds a unit phosphor region be a rectangle, the resin layer be applied on the barrier rib top surfaces and the unit phosphor regions in parallel with a shorter side of the rectangle with a width narrower than a longer side of the rectangle, and the peeling member be mechanically peeled off along a direction parallel with the longer side of the rectangle. Such a constitution enables reliable removal of the parts of the conductive material layer which parts are situated on the barrier rib top surfaces, prevention of unexpected removal of other parts of the conductive material layer, and easy control of the thickness of the resin layer.

In the method of manufacturing the anode panel for the flat-panel display device or the method of manufacturing the flat-panel display device according to the second embodiment of the present invention including the above-described preferred constitutions (these manufacturing methods may hereinafter be abbreviated collectively to a manufacturing method according to the second embodiment of the present invention) or the manufacturing method according to the first embodiment of the present invention including the various preferred forms described above, the anode panel further includes a feeding section having a projection-depression shape formed simultaneously with formation of the barrier ribs; an anode electrode unit situated at an outermost peripheral part of the anode panel is connected to an anode electrode control circuit via the feeding section; a feeding section conductive material layer is formed on an entire surface of the feeding section simultaneously with formation of the conductive material layer; parts of the feeding section conductive material layer which parts are situated on feeding section projection parts are removed simultaneously with removal of the parts of the conductive material layer which parts are situated on the barrier rib top surfaces; and a feeding section resistor layer for electrically connecting the feeding section conductive material layer situated in adjacent depression parts of the feeding section is formed on the feeding section projection parts.

Incidentally, the thus composed manufacturing method will be referred to as a manufacturing method according to a first-A embodiment of the present invention or according to a second-A embodiment of the present invention for convenience.

Further, in the manufacturing method according to the first embodiment of the present invention or the manufacturing method according to the second embodiment of the present invention including the various preferred forms described above, one pixel can be formed by a red light emitting unit phosphor region, a green light emitting unit phosphor region, and a blue light emitting unit phosphor region.

According to a third embodiment of the present invention, there is provided a method of manufacturing an anode panel for a flat-panel display device, the anode panel for the flat-panel display device including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, (E) a resistor layer for electrically connecting adjacent anode electrode units to each other, and (F) a feeding section having a projection-depression shape for connecting an anode electrode unit situated at an outermost peripheral part of the anode panel to an anode electrode control circuit, the method including: a step of forming the feeding section having the projection-depression shape on the substrate, then forming a feeding section conductive material layer on an entire surface of the feeding section, and next removing parts of the feeding section conductive material layer which parts are situated on feeding section projection parts; and a step of forming a feeding section resistor layer for electrically connecting the feeding section conductive material layer situated in adjacent depression parts of the feeding section on the feeding section projection parts after forming the feeding section having the projection-depression shape on the substrate or after removing the parts of the feeding section conductive material layer which parts are situated on the feeding section projection parts.

According to the third embodiment of the present invention, there is provided a method of manufacturing a flat-panel display device, the flat-panel display device being formed by joining an anode panel and a cathode panel having a plurality of electron emission elements to each other at peripheral parts of the anode panel and the cathode panel, the anode panel including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, (E) a resistor layer for electrically connecting adjacent anode electrode units to each other, and (F) a feeding section having a projection-depression shape for connecting an anode electrode unit situated at an outermost peripheral part of the anode panel to an anode electrode control circuit, the anode panel being manufactured by the manufacturing method including: a step of forming the feeding section having the projection-depression shape on the substrate, then forming a feeding section conductive material layer on an entire surface of the feeding section, and next removing parts of the feeding section conductive material layer which parts are situated on feeding section projection parts; and a step of forming a feeding section resistor layer for electrically connecting the feeding section conductive material layer situated in adjacent depression parts of the feeding section on the feeding section projection parts after forming the feeding section having the projection-depression shape on the substrate or after removing the parts of the feeding section conductive material layer which parts are situated on the feeding section projection parts.

In the method of manufacturing the anode panel for the flat-panel display device or the method of manufacturing the flat-panel display device according to the third embodiment of the present invention (these manufacturing methods may hereinafter be abbreviated collectively to a manufacturing method according to the third embodiment of the present invention), forms in which the feeding section resistor layer is formed include a form in which the feeding section resistor layer is formed on the feeding section projection parts, a form in which the feeding section resistor layer is formed so as to extend from on the feeding section projection parts to on side surfaces of the feeding section, and a form in which the feeding section resistor layer is formed on the entire feeding section. The anode electrode unit situated at the outermost peripheral part of the anode panel and the feeding section (more specifically the feeding section conductive material layer situated in a depression part of the feeding section) are electrically connected to each other by the feeding section resistor layer. The feeding section may be disposed in an ineffective region (a frame-shaped region surrounding an effective region as a central display area performing practical functions of the cold cathode field electron emission display device).

The method of manufacturing the anode panel for the flat-panel display device or the method of manufacturing the flat-panel display device according to the third embodiment of the present invention, the manufacturing method according to the first-A embodiment of the present invention, or the manufacturing method according to the second-A embodiment of the present invention can further include a step of forming a resin layer on the feeding section projection parts before forming the feeding section conductive material layer on the entire surface of the feeding section, wherein the resin layer can be removed by performing heat treatment after forming the feeding section conductive material layer on the entire surface of the feeding section or after removing the parts of the feeding section conductive material layer which parts are situated on the feeding section projection parts. When such a resin layer is formed, the resin layer functions to protect the unit phosphor regions in various steps in manufacturing the anode panel. It is therefore possible to reliably prevent damage from being caused to the unit phosphor regions, and make the anode electrode units obtain a mirror surface.

Table 2 below collectively shows orders of the step of forming the feeding section having the projection-depression shape on the substrate [feeding section forming step], the step of forming the feeding section conductive material layer on the entire surface of the feeding section [feeding section conductive material layer forming step], the step of removing the parts of the feeding section conductive material layer which parts are situated on the feeding section projection parts [feeding section conductive material layer partial removal step], the step of forming the feeding section resistor layer for electrically connecting the feeding section conductive material layer situated in adjacent depression parts of the feeding section on the feeding section projection parts [feeding section resistor layer forming step], the step of forming the resin layer on the feeding section projection parts [resin layer forming step], and the step of removing the resin layer by performing heat treatment [resin layer removing step].

TABLE 2

| | | | | | | | |
|---|---|---|---|---|---|---|---|
| Feeding section | 1 | 1 | 1 | 1 | 1 | 1 | 1 |
| forming step | | | | | | | |
| Feeding section | 3 | 3 | 4 | 4 | 4 | 4 | 3 |
| conductive | | | | | | | |
| material layer | | | | | | | |
| forming step | | | | | | | |
| Feeding section | 4 | 4 | 6 | 5 | 5 | 6 | 5 |
| conductive | | | | | | | |
| material layer | | | | | | | |
| partial removal | | | | | | | |
| step | | | | | | | |
| Feeding section | 6 | 5 | 2 | 2 | 3 | 3 | 6 |
| resistor layer | | | | | | | |
| forming step | | | | | | | |
| Resin layer | 2 | 2 | 3 | 3 | 2 | 2 | 2 |
| forming step | | | | | | | |
| Resin layer | 5 | 6 | 5 | 6 | 6 | 5 | 4 |
| removing step | | | | | | | |

In the method of manufacturing the anode panel for the flat-panel display device or the method of manufacturing the flat-panel display device according to the third embodiment of the present invention including the above-described preferred constitutions, a peeling member is attached to the parts of the feeding section conductive material layer which parts are situated on the feeding section projection parts, and then the peeling member is mechanically peeled off, whereby the parts of the feeding section conductive material layer which parts are situated on the feeding section projection parts can be removed. Incidentally, such a manufacturing method will be abbreviated to a manufacturing method according to a third-A embodiment of the present invention for convenience. In this case, it is desirable that the peeling member include a cohesive layer or an adhesive layer, and a retaining film (supporting film) for retaining the cohesive layer or the adhesive layer, and that a method of attaching the peeling member to the parts of the feeding section conductive material layer which parts are situated on the feeding section projection parts be a method of pressure-bonding the cohesive layer or the adhesive layer forming the peeling member to the parts of the feeding section conductive material layer which parts are situated on the feeding section projection parts. Incidentally, the same applies to the manufacturing method according to the first-A embodiment of the present invention and the manufacturing method according to the second-A embodiment of the present invention.

Alternatively, in the method of manufacturing the anode panel for the flat-panel display device or the method of manufacturing the flat-panel display device according to the third embodiment of the present invention including the above-described preferred constitutions, it is desirable that the parts of the feeding section conductive material layer which parts are situated on the feeding section projection parts be removed by applying an etchant to the parts of the feeding section conductive material layer which parts are situated on the feeding section projection parts. Incidentally, such a manufacturing method will be abbreviated to a manufacturing method according to a third-B embodiment of the present invention for convenience. Incidentally, the same applies to the manufacturing method according to the first-A embodiment of the present invention and the manufacturing method according to the second-A embodiment of the present invention.

According to the present invention, there is provided an anode panel for a flat-panel display device, the anode panel for the flat-panel display device including: (A) a substrate; (B) a plurality of unit phosphor regions formed on the substrate; (C) lattice-shaped barrier ribs surrounding each unit phosphor region; (D) an anode electrode unit made of a conductive material layer and formed so as to extend from on each unit phosphor region to on barrier ribs; (E) a resistor layer for electrically connecting adjacent anode electrode units to each other; and (F) a feeding section having a projection-depression shape for connecting an anode electrode unit situated at an outermost peripheral part of the anode panel to an anode electrode control circuit; wherein the feeding section has the projection-depression shape, a feeding section conductive material layer is formed in depression parts of the feeding section, and a feeding section resistor layer for electrically connecting the feeding section conductive material layer situated in adjacent depression parts of the feeding section is formed on projection parts of the feeding section.

In addition, according to the present invention, there is provided a flat-panel display device including: an anode panel including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, (E) a resistor layer for electrically connecting adjacent anode electrode units to each other, and (F) a feeding section having a projection-depression shape for connecting an anode electrode unit situated at an outermost peripheral part of the anode panel to an anode electrode control circuit; and a cathode panel having a plurality of electron emission elements; the flat-panel display device being formed by joining the anode panel and the cathode panel to each other at peripheral parts of the anode panel and the cathode panel; wherein the feeding section has the projection-depression shape, a feeding section conductive material layer is formed in depression parts of the feeding section, and a feeding section resistor layer for electrically connecting the feeding section conductive material layer situated in adjacent depression parts of the feeding section is formed on projection parts of the feeding section.

In the anode panel for the flat-panel display device and the flat-panel display device according to the present invention, it is desirable that the plan shape of a set of anode electrode units (anode electrode units arranged in the form of a two-dimensional matrix) be a rectangle, and that main parts of the depression parts of the feeding section and main parts of the projection parts of the feeding section extend substantially in parallel with sides of the rectangle.

In the methods of manufacturing the anode panels for the flat-panel display devices according to the first to third embodiments of the present invention, the methods of manufacturing the flat-panel display devices according to the first to third embodiments of the present invention, the anode panel for the flat-panel display device according to the present invention, or the flat-panel display device according to the present invention including the preferred forms and constitutions described above (these may hereinafter be abbreviated collectively to the present invention), the substrate for forming the anode panel or a support for forming the cathode panel includes a glass substrate, a glass substrate having an insulating film formed on a surface thereof, a quartz substrate, a quartz substrate having an insulating film formed on a surface thereof, and a semiconductor substrate having an insulating film formed on a surface thereof. From a viewpoint of decrease in production cost, it is desirable to use a glass substrate or a glass substrate having an insulating film formed on a surface thereof. Examples of the glass substrate include high strain point glass, soda glass (Na₂O.CaO.SiO₂), borosilicate glass (Na₂O.B₂O₃.SiO₂), forsterite (2MgO.SiO₂) and lead glass (Na₂O.PbO.SiO₂).

In the present invention, barrier ribs are provided to prevent a so-called optical crosstalk (color turbidity) that is caused when electrons recoiling from a unit phosphor region or secondary electrons emitted from a unit phosphor region enter another unit phosphor region, or to prevent electrons recoiling from a unit phosphor region or secondary electrons emitted from a unit phosphor region from colliding with another unit phosphor region when these electrons enter the other unit phosphor region over a barrier rib.

Examples of a method of forming lattice-shaped barrier ribs or a method of forming a feeding section having a projection-depression shape include a screen printing method, a dry film method, a photosensitive method, a casting method, and a sandblasting forming method. The screen printing method is a method in which a screen has openings in parts of the screen which parts correspond to parts in which to form barrier ribs or a feeding section, a material for forming the barrier ribs (feeding section) on the screen is allowed to pass through the openings with a squeegee to form a material layer for forming the barrier ribs (feeding section) on a substrate, and the material layer for forming the barrier ribs (feeding section) is fired. The dry film method is a method in which a photosensitive film is laminated on a substrate, parts of the photosensitive film in which parts barrier ribs (feeding section) are to be formed are removed by exposure and development, a material for forming the barrier ribs (feeding section) is embedded in openings formed by the removal, and the material for forming the barrier ribs (feeding section) is fired. The photosensitive film is burned and removed by the firing, and the material for forming the barrier ribs (feeding section) embedded in the openings remains to form the barrier ribs (feeding section). The photosensitive method is a method in which a photosensitive material layer for forming barrier ribs (feeding section) is formed on a substrate, and the material layer for forming the barrier ribs (feeding section) is patterned by exposure and development and then fired (hardened). The casting method (mold press forming method) is a method in which a material layer for forming barrier ribs (feeding section) which layer is formed of an organic material or an inorganic material in a paste form by pushing out the material layer for forming the barrier ribs (feeding section) onto a substrate from a mold (cast), and then the material layer for forming the barrier ribs (feeding section) is fired. The sandblasting forming method is a method in which a material layer for forming barrier ribs (feeding section) is formed on a substrate by using for example screen printing, metal mask printing, a roll coater, a doctor blade, and a nozzle ejection type coater, the material layer for forming the barrier ribs (feeding section) is dried, thereafter parts of the material layer for forming the barrier ribs (feeding section) in which parts to form the barrier ribs (feeding section) are covered with a mask layer, and then exposed parts of the material layer for forming the barrier ribs (feeding section) are removed by a sandblasting method. After the barrier ribs (feeding section) are formed, the barrier ribs (feeding section) may be polished to flatten barrier rib top surfaces (feeding section projection parts).

The material for forming the barrier ribs (feeding section) includes for example photosensitive polyimide resin, lead glass colored black by a metal oxide such as cobalt oxide or the like, SiO₂, low melting point glass paste. A protective layer (composed of for example SiO₂, SiON, or AlN) for preventing the collision of an electron beam with a barrier rib and the emission of a gas from the barrier rib may be formed on surfaces (top surfaces and side surfaces) of the barrier ribs.

Examples of the plan shape of a part surrounding a unit phosphor region in the lattice-shaped barrier ribs (which part corresponds to an inside contour line of a projection image of side surfaces of barrier ribs and is a kind of opening region) include a rectangular shape, a circular shape, an elliptical shape, an oval shape, a triangular shape, a polygonal shape having five or more angles, a rounded triangular shape, a rounded rectangular shape, and a rounded polygonal shape. Such plan shapes (plan shapes of opening regions) are arranged in the form of a two-dimensional matrix, whereby the lattice-shaped barrier ribs are formed. This arrangement in the form of a two-dimensional matrix may be for example a grid-like arrangement or a staggered arrangement.

The material for forming the conductive material layer and the feeding section conductive material layer includes: metals such as molybdenum (Mo), aluminum (Al), chromium (Cr), tungsten (W), niobium (Nb), tantalum (Ta), gold (Au), silver (Ag), titanium (Ti), cobalt (Co), zirconium (Zr), iron (Fe), platinum (Pt), zinc (Zn), and the like; alloys or compounds (for example nitrides such as TiN and the like and silicides such as WSi₂, MoSi₂, TiSi₂, TaSi₂ and the like) including these metal elements; semiconductors such as silicon (Si) and the like; carbon thin films of diamond and the like; and conductive metal oxides such as ITO (indium oxide-tin), indium oxide, zinc oxide and the like. Incidentally, when the material for forming the conductive material layer and the feeding section conductive material layer is changed in quality due to a oxidation-reduction reaction in a process of assembling the anode panel and the cathode panel, a protective layer (composed of for example SiO₂, SiON, or AlN) may be formed in parts other than parts requiring electric connection to protect the parts other than the parts requiring electric connection for a purpose of suppressing such a quality change.

A method of forming the conductive material layer and the feeding section conductive material layer includes for example: various physical vapor deposition (PVD) methods such for example as deposition methods such as an electron beam deposition method, a hot filament deposition method and the like, a sputtering method, an ion plating method, and a laser ablation method; various chemical vapor deposition methods; a screen printing method; a metal mask printing method; a lift-off method; and a sol-gel method. An average thickness of the conductive material layer and the feeding section conductive material layer on a substrate (or above the substrate) is for example 5×10⁻⁸ m (50 nm) to 5×10⁻⁷ m (0.5 μm), and preferably 8×10⁻⁸ m (80 nm) to 3×10⁻⁷ m (0.3 μm).

The material for forming the resistor layer or the feeding section resistor layer (resistor layer forming material) includes: carbon-base materials such as carbon, silicon carbide (SiC), SiCN and the like; SiN-base materials; high melting point metal oxides such as ruthenium oxide (RuO₂), tantalum oxide, tantalum nitride, titanium oxide (TiO₂), chromium oxide and the like; semiconductor materials such as amorphous silicon and the like; and ITO. In addition, a desired stable sheet resistance value can be achieved by a combination of a plurality of films such as a SiC resistance film and a carbon thin film having a low resistance value laminated on the SiC resistance film.

When the resistor layer is formed before unit phosphor regions are formed on parts of a substrate which parts are surrounded by barrier ribs after the lattice-shaped barrier ribs are formed on the substrate, the resistor layer may be formed on barrier rib top surfaces, formed so as to extend from the barrier rib top surfaces to halfway points on barrier rib side surfaces, formed so as to extend over the barrier rib top surfaces and the barrier rib side surfaces, or formed on the barrier ribs and the entire surface of the substrate by a method including for example: various PVD methods such for example as deposition methods such as an electron beam deposition method, a hot filament deposition method and the like, a sputtering method, an ion plating method, and a laser ablation method; combinations of the PVD methods with an etching method; various CVD methods; combinations of the various CVD methods with an etching method; a screen printing method; a metal mask printing method; an application method using a roll coater; a lift-off method; a laser ablation method; and a sol-gel method.

When the resistor layer is formed before a conductive material layer is formed on an entire surface after unit phosphor regions are formed on parts of a substrate which parts are surrounded by barrier ribs, the resistor layer may be formed on barrier rib top surfaces, formed so as to extend from the barrier rib top surfaces to halfway points on barrier rib side surfaces, formed so as to extend over the barrier rib top surfaces and the barrier rib side surfaces, or formed on the barrier ribs and the unit phosphor regions by a method including for example: various PVD methods and CVD methods; a screen printing method; a metal mask printing method; and an application method using a roll coater.

When the resistor layer is formed after parts of a conductive material layer which parts are situated on barrier rib side surfaces are removed, the resistor layer may be formed on the barrier rib top surfaces, formed so as to extend from the barrier rib top surfaces to halfway points on barrier rib side surfaces, formed so as to extend over the barrier rib top surfaces and the barrier rib side surfaces, or formed on the barrier ribs and anode electrode units by a method including for example: various PVD methods and CVD methods; a screen printing method; a metal mask printing method; and an application method using a roll coater.

When the feeding section resistor layer is formed before a feeding section conductive material layer is formed on the entire surface of a feeding section after the feeding section having a projection-depression shape is formed on a substrate, the feeding section resistor layer may be formed on feeding section projection parts, formed so as to extend from the feeding section projection parts to halfway points on feeding section side surfaces, formed so as to extend over the feeding section projection parts and the feeding section side surfaces, or formed on the entire surface of the feeding section by a method including for example: various PVD methods; combinations of the PVD methods with an etching method; various CVD methods; combinations of the various CVD methods with an etching method; a screen printing method; a metal mask printing method; an application method using a roll coater; a lift-off method; a laser ablation method; and a sol-gel method.

When the feeding section resistor layer is formed after parts of a feeding section conductive material layer which parts are situated on feeding section projection parts are removed, the feeding section resistor layer may be formed on the feeding section projection parts, formed so as to extend from the feeding section projection parts to halfway points on feeding section side surfaces, formed so as to extend over the feeding section projection parts and the feeding section side surfaces, or formed on the feeding section and the feeding section conductive material layer by a method including for example: various PVD methods and CVD methods; a screen printing method; a metal mask printing method; and an application method using a roll coater.

Materials for forming the resin layer include lacquer and polyvinyl alcohol (PVA) water solutions. The lacquer is a kind of varnish in a broad sense, and includes a composition including a cellulose derivative, generally nitrocellulose as a main component which composition is dissolved in a volatile solvent such as a lower fatty acid ester, urethane lacquers including other synthetic polymers, acrylic lacquers, and lacquers to which a chromium compound or a manganese compound is added. The polyvinyl alcohol water solutions include polyvinyl alcohol water solutions obtained by mixing a glycol-base solvent and glycerol in a diluted water solution and adjusting a drying rate, and polyvinyl alcohol water solutions to which a chromium compound or a manganese compound is added. Methods for forming the resin layer include: a screen printing method; a metal mask printing method; an application method using a roll coater, a spray coater, or a transfer method; a lacquer floating method (a method in which a resin layer is formed on the surface of water stored in a water tank with a substrate disposed in the water, and the water is drained to deposit the resin layer on the substrate). The resin layer is removed by heat treatment. More specifically, the resin layer may be burned (decomposed and removed) by performing heat treatment at a temperature at which the resin layer burns, for example.

In the manufacturing method according to the first embodiment of the present invention, it is desirable that the peeling member be mechanically peeled off with a peeling force (F) having a component (Fᵥ) in a direction of a normal to the substrate. Incidentally, it suffices for a ratio of the component (Fᵥ) in the direction of the normal to the peeling force (F) to exceed 0% of the value of the peeling force (F). The ratio can be about 100% of the value of the peeling force (F) (that is, a so-called 90-degree peel). Specifically, a peeling force of about 3 to 25 N/25 mm suffices. A method of applying the peeling force (F) may be performed by human power or may use a machine. Methods for pressure-bonding the cohesive layer or the adhesive layer forming the peeling member include specifically a method of applying pressure to the retaining film with a pressure sensitive cohesive layer or a pressure sensitive adhesive layer in contact with the conductive material layer or the feeding section conductive material layer. Methods for applying the pressure include a method using an elastic roller on a contact surface, for example. Preliminary heating of the substrate or heating of the roller may also be employed to stabilize a state of close adhesion. Examples of the retaining film include film base materials composed of polyolefin, PVC, or PET. The thickness of the peeling member as a whole may be determined as appropriate, and is for example a thickness of 40 to 150 μm. Other materials for forming the cohesive layer or the adhesive layer include thermosetting resins and ultraviolet curing resins. When there is a fear of the cohesive layer or the adhesive layer remaining on barrier rib top surfaces after the peeling member is mechanically peeled off, it is desirable that the decomposition of the cohesive layer or the adhesive layer be promoted by irradiating the cohesive layer or the adhesive layer with ultraviolet rays, the decomposition of the cohesive layer or the adhesive layer be promoted by an ozone gas atmosphere, or the cohesive layer or the adhesive layer be removed by applying a remover by an application method using a roll coater or the like.

As a method of applying an etchant in the manufacturing method according to the second embodiment of the present invention, an application method that does not apply the etchant to parts of the conductive material layer other than parts of the conductive material layer which parts are situated on the barrier rib top surfaces needs to be selected. In addition, as a method of applying an etchant in the manufacturing method according to the third-B embodiment of the present invention, an application method that does not apply the etchant to parts of the feeding section conductive material layer other than parts of the feeding section conductive material layer which parts are situated on the feeding section projection parts needs to be selected. Methods for applying the etchant to only the parts of the conductive material layer which parts are situated on the barrier rib top surfaces or the parts of the feeding section conductive material layer which parts are situated on the feeding section projection parts include an application method using a roll coater but are not limited thereto. The IRHD hardness of rolls forming the roll coater is for example 20 to 80. It suffices to select an etchant that allows proper etching of a material forming the conductive material layer or the feeding section conductive material layer. Combinations of the material forming the conductive material layer or the feeding section conductive material layer and the etchant include for example a combination of aluminum and a mixed water solution including acetic acid and nitric acid, a combination of a molybdenum-tungsten alloy and a mixed water solution including phosphoric acid, acetic acid, and nitric acid, and a combination of chromium and a mixed solution including ceric ammonium nitrate and perchloric acid.

The unit phosphor regions may be formed of phosphor particles of a single color or phosphor particles of three primary colors. The unit phosphor regions are arranged in the form of dots. Specifically, when a flat-panel display device makes color display, the disposition or the arrangement of the unit phosphor regions includes a delta arrangement, a stripe arrangement, a diagonal arrangement, and a rectangle arrangement. That is, one column of unit phosphor regions arranged in the form of a straight line may be a column occupied entirely by red light emitting unit phosphor regions, a column occupied entirely by green light emitting unit phosphor regions, or a column occupied entirely by blue light emitting unit phosphor regions. Alternatively, one column of unit phosphor regions arranged in the form of a straight line may include red light emitting unit phosphor regions, green light emitting unit phosphor regions, and blue light emitting unit phosphor regions arranged in order. A unit phosphor region is defined as a phosphor region generating one bright spot on the anode panel. One pixel is formed by a set of one red light emitting unit phosphor region, one green light emitting unit phosphor region, and one blue light emitting unit phosphor region. One subpixel is formed by one unit phosphor region (one red light emitting unit phosphor region, one green light emitting unit phosphor region, or one blue light emitting unit phosphor region).

A unit phosphor region uses a luminous crystalline particle composition prepared from luminous crystalline particles (for example phosphor particles having a particle diameter of about 2 to 10 μm). For example, the unit phosphor regions can be formed by a method in which a red photosensitive luminous crystalline particle composition (red phosphor slurry) is applied to the entire surface, exposed to light and developed to form red light emitting unit phosphor regions, then a green photosensitive luminous crystalline particle composition (green phosphor slurry) is applied to the entire surface, exposed to light and developed to form green light emitting unit phosphor regions, and further a blue photosensitive luminous crystalline particle composition (blue phosphor slurry) is applied to the entire surface, exposed to light and developed to form blue light emitting unit phosphor regions. Alternatively, each unit phosphor region may be formed by sequentially applying a red light emitting phosphor slurry, a green light emitting phosphor slurry, and a blue light emitting phosphor slurry, and sequentially exposing and developing the phosphor slurries. Alternatively, each unit phosphor region may be formed by a screen printing method, an ink jet method, a float application method, a sedimentation application method, a phosphor film transfer method and the like. An average thickness of the unit phosphor regions on the substrate is not limited. However, it is desirable that the average thickness of the unit phosphor regions on the substrate be 3 μm to 20 μm, or preferably 5 μm to 10 μm.

A phosphor material constituting luminous crystalline particles can be selected properly from conventionally known phosphor materials, and used. In the case of color display, it is desirable to combine phosphor materials that are close in color purity to three primary colors defined by the NTSC, achieve a proper white balance when the three primary colors are mixed, have a short afterglow time, and render the afterglow times of the three primary colors substantially equal to each other. Examples of a phosphor material constituting red light emitting unit phosphor regions include (Y₂O₃:Eu), (Y₂O₂S:Eu), (Y₃Al₅O₁₂:Eu), (Y₂SiO₅:Eu), and (Zn₃(PO₄)₂:Mn). Among the examples, (Y₂O₃:Eu) and (Y₂O₂S:Eu) are preferably used. Examples of a phosphor material constituting green light emitting unit phosphor regions include (ZnSiO₂:Mn), (Sr₄Si₃O₈Cl₄:Eu), (ZnS:Cu, Al), (ZnS:Cu, Au, Al), [(Zn, Cd)S:Cu, Al], (Y₃Al₅O₁₂:Tb), (Y₂SiO₅:Tb), [Y₃(Al, Ga)₅O₁₂:Tb], (ZnBaO₄:Mn), (GbBO₃:Tb), (Sr₆SiO₃Cl₃:Eu), (BaMgAl₁₄O₂₃:Mn), (ScBO₃:Tb), (Zn₂SiO₄:Mn), (ZnO:Zn), (Gd₂O₂S:Tb), and (ZnGa₂O₄:Mn). Among the examples, (ZnS:Cu, Al), (ZnS:Cu, Au, Al), [(Zn, Cd)S:Cu, Al], (Y₃Al₅O₁₂:Tb), [Y₃(Al, Ga)₅O₁₂:Tb], and (Y₂SiO₅:Tb) are preferably used. Examples of a phosphor material constituting blue light emitting unit phosphor regions include (Y₂SiO₅:Ce), (CaWO₄:Pb), CaWO₄, YP_{0.85}V_{0.15}O₄, (BaMgAl₁₄O₂₃:Eu), (Sr₂P₂O₇:Eu), (Sr₂P₂O₇:Sn), (ZnS:Ag, Al), (ZnS:Ag), ZnMgO, and ZnGaO₄. Among the examples, (ZnS:Ag) and (ZnS:Ag, Al) are preferably used.

From a viewpoint of improving contrast of a displayed image, it is desirable that a light absorbing layer for absorbing light from the unit phosphor regions be formed between adjacent unit phosphor regions or between the barrier ribs and the substrate. The light absorbing layer functions as a so-called black matrix. As a material for forming the light absorbing layer, a material that absorbs 90% or more of light from the unit phosphor regions is preferably selected. Such materials include carbon, thin metal films (for example made of chromium, nickel, aluminum, molybdenum, or alloys thereof), metal oxides (for example chromium oxide), metal nitrides (for example chromium nitride), heat-resistant organic resins, glass pastes, and glass pastes containing a black pigment or electrically conductive particles of silver or the like. Specific examples thereof include a photosensitive polyimide resin, chromium oxide, and a chromium oxide/chromium laminated film. Incidentally, the chromium film of the chromium oxide/chromium laminated film is in contact with the substrate. The light absorbing layer can be formed by a method selected properly depending on the material being used, for example combinations of a vacuum deposition method and a sputtering method with an etching method, combinations of a vacuum deposition method, a sputtering method, and a spin coating method with an etching method, a screen printing method, a lithography technique and the like.

The electron emission element in the embodiments of the present invention includes a cold cathode field electron emission element (hereinafter abbreviated to a field emission element), a metal-insulator-metal element (MIM element), and a surface conduction type electron emission element. The flat-panel display device includes a flat-panel display device (cold cathode field electron emission display device) having cold cathode field electron emission elements, a flat-panel display device incorporating MIM elements, and a flat-panel display device incorporating surface conduction type electron emission elements.

In the cold cathode field electron emission display device, as a result of applying a strong electric field produced by voltage applied to a cathode electrode and a gate electrode to an electron emission part, electrons are emitted from the electron emission part due to a quantum tunneling effect. The electrons are attracted to the anode panel by an anode electrode unit provided in the anode panel, and collide with a unit phosphor region. As a result of collision of electrons with the unit phosphor regions, the unit phosphor regions emit light, which is perceived as an image.

In the cold cathode field electron emission display device, the cathode electrode is connected to a cathode electrode control circuit, the gate electrode is connected to a gate electrode control circuit, and anode electrode units are connected to an anode electrode control circuit via a feeding section. Incidentally, these control circuits can be formed by a well known circuit. During actual operation, an output voltage V_{A} of the anode electrode control circuit is generally constant, and can be 5 kilovolts to 15 kilovolts, for example. Alternatively, it is desirable that letting d be a distance between the anode panel and the cathode panel (0.5 mm≦d≦10 mm), the value of V_{A}/d (unit: kilovolt/mm) be 0.5 to 20, preferably 1 to 10, or more preferably 5 to 10.

During actual operation of the cold cathode field electron emission display device, as for a voltage V_{C} applied to the cathode electrode and a voltage V_{G} applied to the gate electrode, when a voltage modulation method is employed as a gradation control method, there are:

(1) a method of setting the voltage V_{C} applied to the cathode electrode constant and changing the voltage V_{G} applied to the gate electrode,

(2) a method of changing the voltage V_{C} applied to the cathode electrode and setting the voltage V_{G} applied to the gate electrode constant, and

(3) a method of changing the voltage V_{C} applied to the cathode electrode and changing the voltage V_{G} applied to the gate electrode.

The field emission element more specifically includes:

(a) a cathode electrode in the shape of a stripe formed on a support and extending in a first direction;

(b) an insulating layer formed on the cathode electrode and the support;

(c) a gate electrode in the shape of a strip formed on the insulating layer and extending in a second direction different from the first direction;

(d) an opening part provided in a part of the gate electrode and the insulating layer which part is situated at an overlap part where the cathode electrode and the gate electrode overlap each other, the cathode electrode being exposed at a bottom part of the opening part; and

(e) an electron emission part provided on the cathode electrode exposed at the bottom part of the opening part, electron emission of the electron emission part being controlled by applying voltages to the cathode electrode and the gate electrode.

Types of the field emission element are not specifically limited; the field emission element includes a Spindt-type field emission element (a field emission element in which a conical-shaped electron emission part is provided on the cathode electrode situated at the bottom part of the opening part) and a plane-type field emission element (a field emission element in which a substantially flat electron emission part is provided on the cathode electrode situated at the bottom part of the opening part).

It is desirable from a viewpoint of simplifying the structure of the cold cathode field electron emission display device that a projection image of the cathode electrode and a projection image of the gate electrode be orthogonal to each other, that is, that the first direction and the second direction be orthogonal to each other. The overlap part where the cathode electrode and the gate electrode overlap each other in the cathode panel corresponds to an electron emission region. Electron emission regions are arranged in the form of a two-dimensional matrix. Each electron emission region is provided with one or a plurality of field emission elements.

The field emission element can generally be formed by a method including:

(1) a step of forming a cathode electrode on a support;

(2) a step of forming an insulating layer on an entire surface (on the support and the cathode electrode);

(3) a step of forming a gate electrode on the insulating layer;

(4) a step of forming an opening part in a part of the gate electrode and the insulating layer which part is situated at an overlap part where the cathode electrode and the gate electrode overlap each other, and exposing the cathode electrode at a bottom part of the opening part; and

(5) a step of forming an electron emission part on the cathode electrode situated at the bottom part of the opening part.

Alternatively, the field emission element can be formed by a method including:

(1) a step of forming a cathode electrode on a support;

(2) a step of forming an electron emission part on the cathode electrode;

(3) a step of forming an insulating layer on an entire surface (on the support and the electron emission part or on the support, the cathode electrode, and the electron emission part);

(4) a step of forming a gate electrode on the insulating layer; and

(5) a step of forming an opening part in a part of the gate electrode and the insulating layer which part is situated at an overlap part where the cathode electrode and the gate electrode overlap each other, and exposing the electron emission part at a bottom part of the opening part.

The field emission element may be provided with a converging electrode. The converging electrode is formed above the insulating layer with an interlayer insulating layer between the converging electrode and the insulating layer. The converging electrode converges the trajectories of emitted electrons emitted from the opening part and going toward an anode electrode unit, and can thereby improve luminance and prevent an optical crosstalk between adjacent pixels. The converging electrode is effective especially in a so-called high voltage type cold cathode field electron emission display device in which a potential difference between the anode electrode unit and the cathode electrode is on the order of a few kilovolts and a distance between the anode electrode unit and the cathode electrode is relatively long. A relatively negative voltage (for example zero volts) is applied from a converging electrode control circuit to the converging electrode. The converging electrode does not necessarily need to be formed individually so as to surround each electron emission part or electron emission region provided at the overlap region where the cathode electrode and the gate electrode overlap each other. For example, the converging electrode may be extended in a predetermined direction of arrangement of electron emission parts or electron emission regions. Alternatively, one converging electrode may surround all electron emission parts or electron emission regions (that is, the converging electrode may have a structure in the form of one thin sheet covering an entire effective region as a central display area performing practical functions of the cold cathode field electron emission display device). Thereby a common converging effect can be produced on the plurality of electron emission parts or electron emission regions.

The material for forming the cathode electrode, the gate electrode, and the converging electrode includes for example: various metals including transition metals such as chromium (Cr), aluminum (Al), tungsten (W), niobium (Nb), tantalum (Ta), molybdenum (Mo), copper (Cu), gold (Au), silver (Ag), titanium (Ti), nickel (Ni), cobalt (Co), zirconium (Zr), iron (Fe), platinum (Pt), zinc (Zn) and the like; alloys (for example MoW) or compounds (for example nitrides such as TiN and the like and silicides such as WSi₂, MoSi₂, TiSi₂, TaSi₂ and the like) including these metal elements; semiconductors such as silicon (Si) and the like; carbon thin films of diamond and the like; and conductive metal oxides such as ITO (indium oxide-tin), indium oxide, zinc oxide and the like. Methods for forming these electrodes include for example: combinations of deposition methods such as an electron beam deposition method, a hot filament deposition method and the like, a sputtering method, a CVD method, and an ion plating method with an etching method; a screen printing method; a plating method (an electroplating method and an electroless plating method); a lift-off method; a laser ablation method; and a sol-gel method. The cathode electrode and the gate electrode in the shape of a stripe, for example, can be directly formed by a screen printing method or a plating method.

Material for forming an electron emission part in a Spindt-type field emission element includes at least one kind of material selected from a group consisting of molybdenum, molybdenum alloys, tungsten, tungsten alloys, titanium, titanium alloys, niobium, niobium alloys, tantalum, tantalum alloys, chromium, chromium alloys, and silicon including an impurity (polysilicon and amorphous silicon). The electron emission part in the Spindt-type field emission element can be formed by not only a vacuum deposition method but also a sputtering method and a CVD method, for example.

An electron emission part in a plane-type field emission element is preferably made of a material having a smaller work function Φ than a material for forming a cathode electrode. The material for forming an electron emission part may be selected on the basis of the work function of a material for forming the cathode electrode, a potential difference between the gate electrode and the cathode electrode, a required current density of emitted electrons, and the like. Typical examples of the material for forming the cathode electrode in the field emission element include tungsten (Φ=4.55 eV), niobium (Φ=4.02 to 4.87 eV), molybdenum (Φ=4.53 to 4.95 eV), aluminum (Φ=4.28 eV), copper (Φ=4.6 eV), tantalum (Φ=4.3 eV), and chromium (Φ=4.5 eV). The electron emission part preferably has a smaller work function Φ than these materials, and the value of the work function thereof is preferably approximately 3 eV or smaller. Examples of such a material include carbon (Φ<1 eV), cesium (Φ=2.14 eV), LaB₆ (Φ=2.66 to 2.76 eV), BaO (Φ=1.6 to 2.7 eV), SrO (Φ=1.25 to 1.6 eV), Y₂O₃ (Φ=2.0 eV), CaO (Φ=1.6 to 1.86 eV), BaS (Φ=2.05 eV), TiN (Φ=2.92 eV), and ZrN (Φ=2.92 eV). More preferably, the electron emission part is made of a material having a work function Φ of 2 eV or smaller. Incidentally, the material for forming the electron emission part does not necessarily need to have electric conductivity.

Alternatively, the material for forming an electron emission part in a plane-type field emission device may be selected properly from materials having a secondary electron gain δ greater than the secondary electron gain δ of the electrically conductive material for forming a cathode electrode. That is, the above material can be properly selected from: metals such as silver (Ag), aluminum (Al), gold (Au), cobalt (Co), copper (Cu), molybdenum (Mo), niobium (Nb), nickel (Ni), platinum (Pt), tantalum (Ta), tungsten (W), zirconium (Zr) and the like; semiconductors such as germanium (Ge) and the like; inorganic simple substances such as carbon, diamond and the like; and compounds such as aluminum oxide (Al₂O₃), barium oxide (Bao), beryllium oxide (BeO), calcium oxide (CaO), magnesium oxide (MgO), tin oxide (SnO₂), barium fluoride (BaF₂), calcium fluoride (CaF₂) and the like. Incidentally, the material for forming an electron emission part does not necessarily need to have electric conductivity.

Alternatively, a particularly preferable material for forming an electron emission part in a plane-type field emission element includes carbon, more specifically amorphous diamond, graphite, carbon nanotube structures, ZnO whiskers, MgO whiskers, SnO₂ whiskers, MnO whiskers, Y₂O₃ whiskers, NiO whiskers, ITO whiskers, In₂O₃ whiskers, and Al₂O₃ whiskers. When the electron emission part is formed of these materials, an emitted electron current density necessary for the cold cathode field electron emission display device can be obtained at an electric field intensity of 5×10⁶ V/m or lower. Further, when the material for forming electron emission parts is an electric resistor, emitted electron currents obtained from the electron emission parts can be made uniform, and variations in luminance can be suppressed when the electron emission parts are incorporated into the cold cathode field electron emission display device. Further, the above materials exhibit very high resistance to a sputtering effect of ions of residual gas within the cold cathode field electron emission display device, thus lengthening the life of field emission elements.

Specifically, the carbon nanotube structure includes a carbon nanotube and/or a graphite nanofiber. More specifically, the electron emission part may be composed of a carbon nanotube, the electron emission part may be composed of a graphite nanofiber, or the electron emission part may be composed of a mixture of a carbon nanotube and a graphite nanofiber. Macroscopically, the carbon nanotube and the graphite nanofiber may be in the form of powder or thin film. The carbon nanotube structure may have a conical shape in some cases. The carbon nanotube and the graphite nanofiber can be manufactured or formed by PVD methods such as a well known arc discharge method, a laser ablation method and the like, and various CVD methods such as a plasma CVD method, a laser CVD method, a thermal CVD method, a vapor phase synthesis method, a vapor phase growth method and the like.

As a material for forming the insulating layer and the interlayer insulating layer, SiO₂-base materials such as SiO₂, BPSG, PSG, BSG, AsSG, PbSG, SiON, SOG (spin-on glass), low melting point glass, glass paste and the like; SiN-base materials; and insulative resins such as polyimide and the like can be used alone or in combination as appropriate. A publicly known process such as a CVD method, an application method, a sputtering method, a screen printing method or the like can be used to form the insulating layer and the interlayer insulating layer.

The plan shape of the first opening part (the opening part formed in the gate electrode) or the second opening part (the opening part formed in the insulating layer) (the plan shape is obtained by cutting the opening part in an imaginary plane in parallel with the surface of the support) may be an arbitrary shape such as a circular shape, an elliptical shape, a rectangular shape, a polygonal shape, a rounded triangular shape, a rounded polygonal shape and the like. The first opening part can be formed by for example anisotropic etching, isotropic etching or a combination of anisotropic etching and isotropic etching. Alternatively, the first opening part can be directly formed, depending on the method of forming the gate electrode. The second opening part can also be formed by for example anisotropic etching, isotropic etching or a combination of anisotropic etching and isotropic etching.

In a field emission element, depending on the structure of the field emission element, one electron emission part may be present within one opening part; a plurality of electron emission parts may be present within one opening part; or a plurality of first opening parts are provided in the gate electrode, one second opening part communicating with the first opening parts is provided in the insulating layer, and one or a plurality of electron emission parts may be present within the one second opening part provided in the insulating layer.

The field emission element may have a resistor thin film formed between the cathode electrode and the electron emission part. The formed resistor thin film can stabilize the operation of the field emission element and uniformize electron emission characteristics of the field emission element. A material for forming the resistor thin film includes for example carbon-base resistor materials such as silicon carbide (SiC) and SiCN, semiconductor resistor materials such as amorphous silicon, SiN and the like, and high melting point metal oxides such as ruthenium oxide (RuO₂), tantalum oxide, tantalum nitride and the like. Methods for forming the resistor thin film include for example a sputtering method, a CVD method, and a screen printing method. The electric resistance value of one electron emission part is approximately 1×10⁶ to 1×10¹¹Ω, preferably a few ten gigaohms.

The cathode panel and the anode panel are bonded to each other in peripheral parts thereof. The bonding may be performed using an adhesive layer or may be performed using both a frame made of an insulating rigid material such as glass, ceramic or the like and an adhesive layer. When both the frame and the adhesive layer are used, by properly selecting the height of the frame, a facing distance between the cathode panel and the anode panel can be set longer than when only the adhesive layer is used. While frit glass is common as a material for forming the adhesive layer, a so-called low melting point metal material having a melting point of about 120 to 400° C. may be used. Such low melting point metal materials include for example: In (indium: a melting point of 157° C.); indium-gold-base low melting point alloys; tin (Sn)-base high-temperature solders such as Sn₈₀Ag₂₀ (a melting point of 220 to 370° C.), Sn₉₅Cu₅ (a melting point of 227 to 370° C.) and the like; lead (Pb)-base high-temperature solders such as Pb_{97.5}Ag_{2.5} (a melting point of 304° C.), Pb_{94.5}Ag_{5.5} (a melting point of 304 to 365° C.), Pb_{97.5}Ag_{1.5}Sn_{1.0} (a melting point of 309° C.) and the like; zinc (Zn)-base high-temperature solders such as Zng₅Al₅ (a melting point of 380° C.) and the like; tin-lead-base standard solders such as Sn₅Pb₉₅ (a melting point of 300 to 314° C.), Sn₂Pb₉₈ (a melting point of 316 to 322° C.) and the like; and brazing materials such as Au₈₈Ga₁₂ (a melting point of 381° C.) and the like (all of the above subscripts represent atomic %).

When the three of the cathode panel, the anode panel, and the frame are bonded to each other, the three may be bonded to each other at the same time. Alternatively, one of the cathode panel and the anode panel may be bonded to the frame in a first step, and the other of the cathode panel and the anode panel may be bonded to the frame in a second step. When the simultaneous bonding of the three or the bonding in the second step is performed in a high-vacuum atmosphere, a space sandwiched between the cathode panel and the anode panel (which space is more specifically a space surrounded by the cathode panel, the anode panel, the frame, and the adhesive layer, and may hereinafter be referred to simply as a space) becomes a vacuum simultaneously with the bonding. Alternatively, the space may be evacuated to form a vacuum after completion of the bonding of the three. When the evacuation is carried out after the bonding, the pressure of an atmosphere at the time of the bonding may be either of an atmospheric pressure and a reduced pressure, and a gas forming the atmosphere may be an atmosphere or an inert gas including nitrogen gas or a gas belonging to group 0 of the periodic table (for example Ar gas).

When the evacuation is carried out, the evacuation can be carried out through a tip tube connected in advance to the cathode panel and/or the anode panel. The tip tube is typically made of a glass tube. The tip tube is joined to the periphery of a through hole provided in an ineffective region of the cathode panel and/or the anode panel by using a frit glass or a low melting point metal material as described above. After the space reaches a predetermined vacuum degree, the tip tube is sealed by heating fusion. Incidentally, a process of temporarily heating the whole of the cold cathode field electron emission display device and then lowering the temperature of the cold cathode field electron emission display device before the sealing is suitable because a residual gas can be released into the space and the residual gas can be removed out of the space by the evacuation.

Since the space has become a vacuum, the flat-panel display device is damaged by atmospheric pressure unless a spacer is disposed between the cathode panel and the anode panel.

The spacer can be formed of ceramic or glass, for example. When the spacer is formed of ceramic, the ceramic includes for example mullite, alumina, barium titanate, titanate zirconate, zirconia, cordierite, barium borosilicate, iron silicate, and glass ceramic material, as well as materials obtained by adding titanium oxide, chromium oxide, iron oxide, vanadium oxide, and nickel oxide to the above materials. In this case, the spacer can be manufactured by forming a so-called green sheet, firing the green sheet, and cutting the green sheet fired product. In addition, glass for forming the spacer includes soda-lime glass. It suffices to insert the spacer between a barrier rib and a barrier rib and fix the spacer, for example. Alternatively, it suffices to form a spacer retaining part in the anode panel and fix the spacer by the spacer retaining part, for example.

The surface of the spacer may be provided with an antistatic film. A material for forming the antistatic film preferably has a secondary electron emission coefficient thereof close to one. Semimetals such as graphite and the like, oxides, borides, carbides, sulfides, nitrides, and the like can be used as the material for forming the antistatic film. For example, the material for forming the antistatic film includes semimetals such as graphite and the like, compounds including semimetal elements such as MoSe₂ and the like, oxides such as Cr₂O₃, Nd₂O₃, LaxBa₂₋ₓCuO₄, LaₓY₁₋ₓCrO₃ and the like, borides such as AlB₂, TiB₂ and the like, carbides such as SiC and the like, sulfides such as MOS₂, WS₂ and the like, and nitrides such as BN, TiN, AlN and the like. Further, materials described in Japanese Patent Laid-Open No. 2004-500688, for example, can be used. The antistatic film may be formed of a single kind of material, a plurality of kinds of material, a single-layer structure, or a multilayer structure. The antistatic film can be formed by well known methods such as a sputtering method, a vacuum deposition method, a CVD method and the like.

The method of manufacturing the anode panel for the flat-panel display device or the method of manufacturing the flat-panel display device according to the first embodiment or the second embodiment of the present invention removes the parts of the conductive material layer which parts are situated on the barrier rib top surfaces by a physical method of mechanically peeling off the peeling member or by a chemical method of applying an etchant to the parts of the conductive material layer which parts are situated on the barrier rib top surfaces. It is therefore possible to reliably prevent damage to phosphor regions. As a result, a flat-panel display device having a high display quality can be provided.

In the method of manufacturing the anode panel for the flat-panel display device or the method of manufacturing the flat-panel display device according to the third embodiment of the present invention, or the anode panel for the flat-panel display device or the flat-panel display device according to the present invention, the feeding section has a projection-depression shape, so that the area of parts of the feeding section which parts face the cathode panel can be further decreased, and consequently discharge between the feeding section and electron emission elements can be further reduced.

### BRIEF DESCRIPTION OF THE DRAWINGS

FIG. 1 is a schematic partial end view of a flat-panel display device according to a first example or a second example having Spindt-type cold cathode field electron emission elements;

FIG. 2 is a schematic partial end view of a flat-panel display device according to the first example or the second example having plane-type cold cathode field electron emission elements;

FIG. 3A schematically shows an example of an arrangement of barrier ribs and unit phosphor regions in an anode panel forming the flat-panel display device according to the first example or the second example, and

FIG. 3B is a partially cutaway schematic perspective view of barrier ribs and unit phosphor regions;

FIG. 4 is a schematic partial plan view of a feeding part and the like in the anode panel forming the flat-panel display device according to the first example or the second example;

FIG. 5 is a schematic partial plan view of a modification of the feeding part and the like in the anode panel forming the flat-panel display device according to the first example or the second example;

FIG. 6 is a schematic partial plan view of modifications of a feeding part and the like in an anode panel forming a flat-panel display device according to the present invention;

FIGS. 7A, 7B, 7C, and 7D are schematic partial end views of a substrate and the like, the schematic partial end views being of assistance in explaining a method of manufacturing the anode panel for the flat-panel display device according to the first example and a method of manufacturing the flat-panel display device;

FIG. 8 is a schematic partial plan view of the substrate and the like, the schematic partial plan view being of assistance in explaining the method of manufacturing the anode panel for the flat-panel display device according to the first example and the method of manufacturing the flat-panel display device;

FIG. 9, continued from FIG. 8, is a schematic partial plan view of the substrate and the like, the schematic partial plan view being of assistance in explaining the method of manufacturing the anode panel for the flat-panel display device according to the first example and the method of manufacturing the flat-panel display device;

FIGS. 10A, 10B, 10C, and 10D, continued from FIGS. 7A, 7B, 7C, and 7D, are schematic partial end views of the substrate and the like, the schematic partial end views being of assistance in explaining the method of manufacturing the anode panel for the flat-panel display device according to the first example and the method of manufacturing the flat-panel display device;

FIG. 11, continued from FIG. 9, is a schematic partial plan view of the substrate and the like, the schematic partial plan view being of assistance in explaining the method of manufacturing the anode panel for the flat-panel display device according to the first example and the method of manufacturing the flat-panel display device;

FIG. 12, continued from FIG. 11, is a schematic partial plan view of the substrate and the like, the schematic partial plan view being of assistance in explaining the method of manufacturing the anode panel for the flat-panel display device according to the first example and the method of manufacturing the flat-panel display device;

FIGS. 13A and 13B, continued from FIGS. 10C and 10D, are schematic partial end views of the substrate and the like, the schematic partial end views being of assistance in explaining the method of manufacturing the anode panel for the flat-panel display device according to the first example and the method of manufacturing the flat-panel display device;

FIGS. 14A and 14B, continued from FIGS. 13A and 13B, are schematic partial end views of the substrate and the like, the schematic partial end views being of assistance in explaining the method of manufacturing the anode panel for the flat-panel display device according to the first example and the method of manufacturing the flat-panel display device;

FIGS. 15A, 15B, 15C, and 15D, continued from FIGS. 14A and 14B, are schematic partial end views of the substrate and the like, the schematic partial end views being of assistance in explaining the method of manufacturing the anode panel for the flat-panel display device according to the first example and the method of manufacturing the flat-panel display device;

FIG. 16, continued from FIG. 12, is a schematic partial plan view of the substrate and the like, the schematic partial plan view being of assistance in explaining the method of manufacturing the anode panel for the flat-panel display device according to the first example and the method of manufacturing the flat-panel display device;

FIG. 17, continued from FIG. 16, is a schematic partial plan view of the substrate and the like, the schematic partial plan view being of assistance in explaining the method of manufacturing the anode panel for the flat-panel display device according to the first example and the method of manufacturing the flat-panel display device;

FIG. 18 is a schematic partial end view of a substrate and the like, the schematic partial end view being of assistance in explaining a method of manufacturing an anode panel for a flat-panel display device according to a second example and a method of manufacturing the flat-panel display device;

FIG. 19 is a schematic partial end view of the substrate and the like, the schematic partial end view being of assistance in explaining the method of manufacturing the anode panel for the flat-panel display device according to the second example and the method of manufacturing the flat-panel display device;

FIGS. 20A and 20B are schematic partial end views of a support and the like, the schematic partial end views being of assistance in explaining a method of manufacturing a Spindt-type cold cathode field electron emission element;

FIGS. 21A and 21B, continued from FIGS. 20A and 20B, are schematic partial end views of the support and the like, the schematic partial end views being of assistance in explaining the method of manufacturing the Spindt-type cold cathode field electron emission element;

FIG. 22 is a schematic partial end view of a Spindt-type cold cathode field electron emission element having a converging electrode;

FIG. 23 is a schematic plan view of an anode electrode in a conventional cold cathode field electron emission display device disclosed in Japanese Patent Laid-Open No. 2004-158232;

FIGS. 24A, 24B, and 24C are schematic partial end views, taken along a line A-A, a line B-B, and a line C-C, respectively, of FIG. 23, of an anode panel in the conventional cold cathode field electron emission display device shown in FIG. 23;

FIG. 25 is a schematic partial end view of the cold cathode field electron emission display device; and

FIG. 26 is a schematic partial perspective view of a cathode panel of the cold cathode field electron emission display device.

### DETAILED DESCRIPTION OF THE PREFERRED EMBODIMENTS

The embodiments of the present invention will hereinafter be described on the basis of examples thereof with reference to the drawings.

### First Example

A first example relates to a method of manufacturing an anode panel for a flat-panel display device according to a first embodiment of the present invention (more specifically a first-A embodiment of the present invention), a method of manufacturing a flat-panel display device according to the first embodiment of the present invention (more specifically the first-A embodiment of the present invention), a method of manufacturing an anode panel for a flat-panel display device according to a third embodiment of the present invention (more specifically a third-A embodiment of the present invention), a method of manufacturing a flat-panel display device according to the third embodiment of the present invention (more specifically the third-A embodiment of the present invention), and an anode panel for a flat-panel display device and a flat-panel display device according to the embodiments of the present invention. Incidentally, the flat-panel display device according to the first example or a second example to be described later is specifically a cold cathode field electron emission display device (hereinafter abbreviated to a display device).

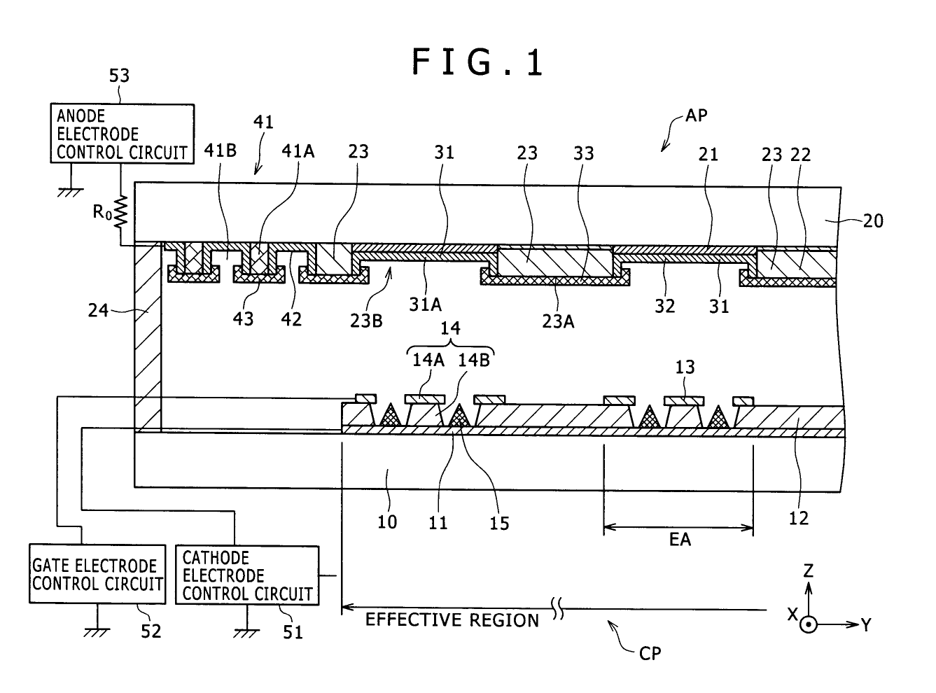

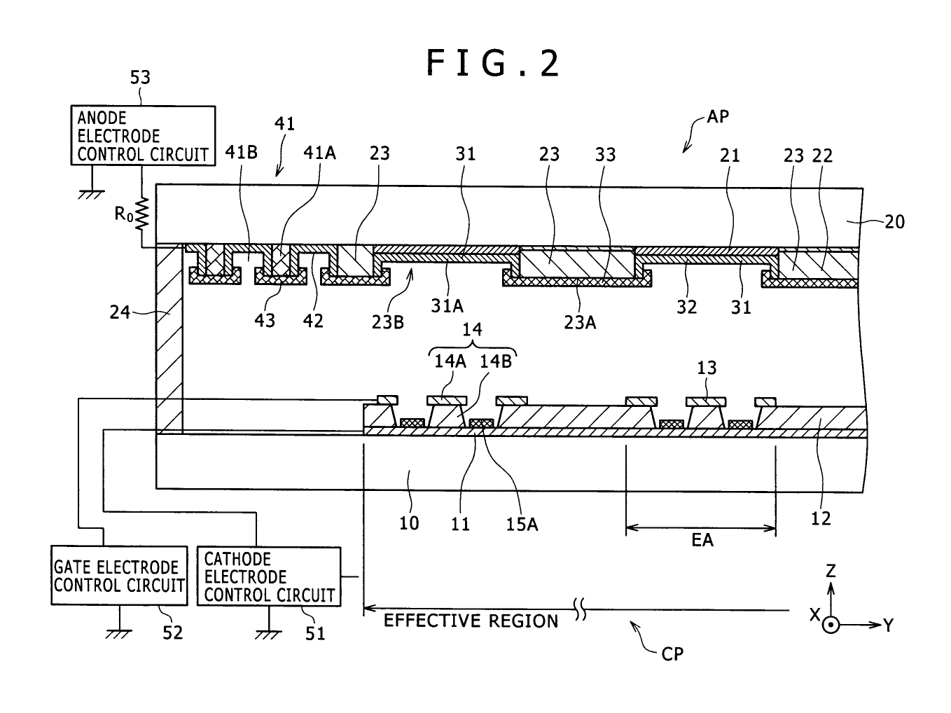

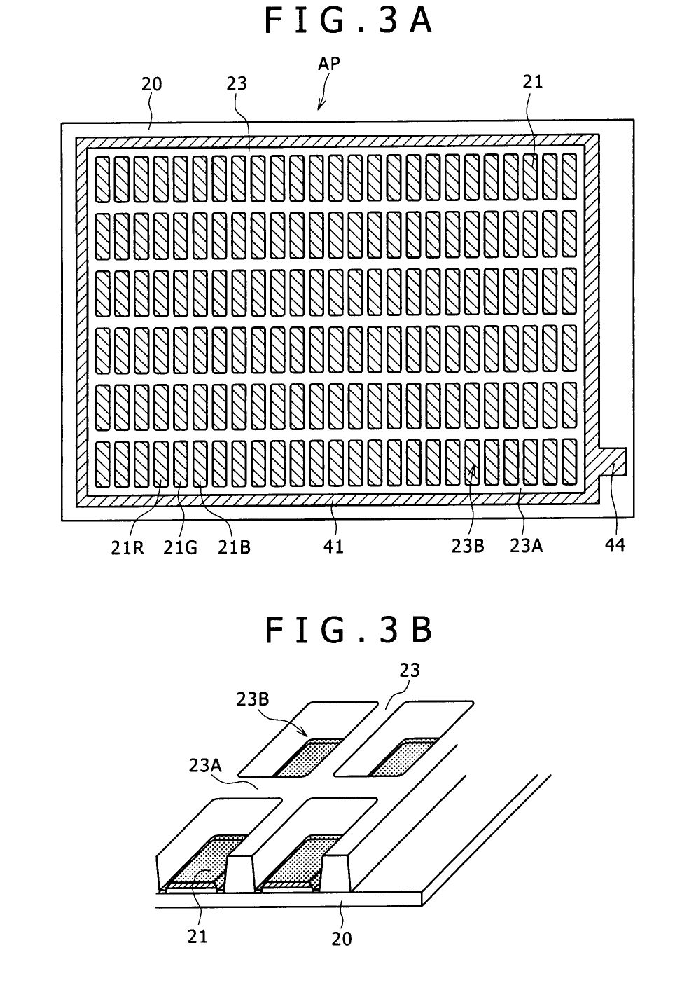

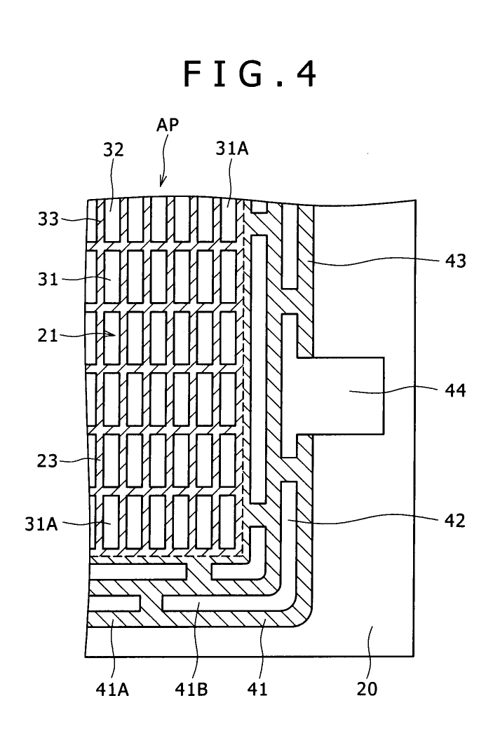

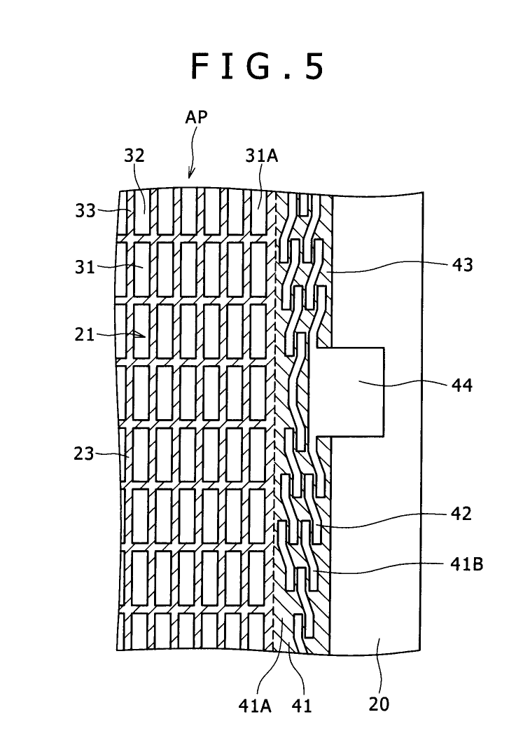

FIG. 1 or FIG. 2 is a schematic partial end view of the display device according to the first example or the second example to be described later. FIG. 3A schematically shows an example of an arrangement of barrier ribs and unit phosphor regions. FIG. 3B is a partially cutaway schematic perspective view of barrier ribs and unit phosphor regions. FIG. 4 or FIG. 5 is a schematic partial plan view of a feeding part and the like.

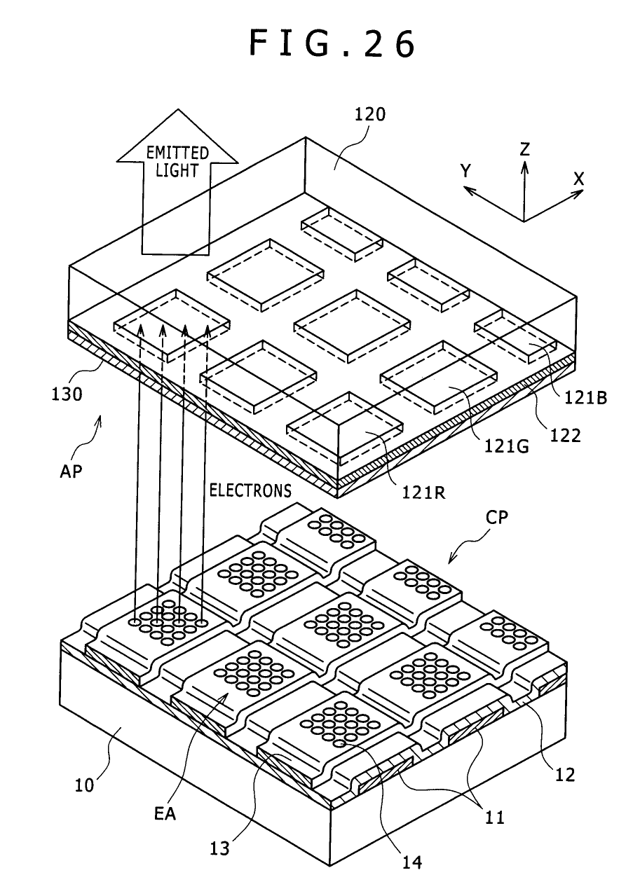

As shown in the schematic partial end view of FIG. 1 or FIG. 2, the display device according to the first example or the second example to be described later is formed by bonding a cathode panel CP having a plurality of electron emission elements to an anode panel AP at peripheral parts of the cathode panel CP and the anode panel AP. A space between the cathode panel CP and the anode panel AP is in a vacuum state (pressure: for example 10⁻³ Pa or lower). Incidentally, a schematic exploded perspective view of a part of the anode panel AP and the cathode panel CP when the cathode panel CP and the anode panel AP are disassembled is basically the same as FIG. 26.

An electron emission element in the first example or the second example to be described later is formed by for example a Spindt-type cold cathode field electron emission element (hereinafter referred to as a field emission element). Specifically, as shown in FIG. 1, a Spindt-type field emission element includes:

(a) a cathode electrode 11 formed on a support 10;

(b) an insulating layer 12 formed on the support 10 and the cathode electrode 11;

(c) a gate electrode 13 formed on the insulating layer 12;

(d) an opening part 14 disposed in the gate electrode 13 and the insulating layer 12 (a first opening part 14A disposed in the gate electrode 13 and a second opening part 14B disposed in the insulating layer 12); and

(e) a conical-shaped electron emission part 15 formed on the cathode electrode 11 situated at a bottom part of the opening part 14.

Alternatively, an electron emission element in the first example or the second example to be described later is formed by for example a plane-type field emission element. Specifically, as shown in FIG. 2, a plane-type field emission element includes:

(a) a cathode electrode 11 formed on a support 10;

(b) an insulating layer 12 formed on the support 10 and the cathode electrode 11;

(c) a gate electrode 13 formed on the insulating layer 12;

(d) an opening part 14 disposed in the gate electrode 13 and the insulating layer 12 (a first opening part 14A disposed in the gate electrode 13 and a second opening part 14B disposed in the insulating layer 12); and

(e) an electron emission part 15A formed on the cathode electrode 11 situated at a bottom part of the opening part 14. The electron emission part 15A in this case is formed by a large number of carbon nanotubes partly embedded in a matrix, for example.

In the cathode panel CP, the cathode electrode 11 is in the shape of a stripe extending in a first direction (see a Y-direction in FIG. 1 or FIG. 2). The gate electrode 13 is in the shape of a strip extending in a second direction different from the first direction (see an X-direction in FIG. 1 or FIG. 2). Projection images of the cathode electrode 11 and the gate electrode 13 are formed each in the shape of a stripe in directions orthogonal to each other. An electron emission region EA corresponding to one subpixel is provided with a plurality of electron emission elements.

The anode panel AP in the first example or the second example to be described later basically includes:

(A) a substrate 20;

(B) a plurality of unit phosphor regions 21 (a red light emitting unit phosphor region 21R, a green light emitting unit phosphor region 21G, and a blue light emitting unit phosphor region 21B) formed on the substrate 20;

(C) lattice-shaped barrier ribs 23 surrounding each unit phosphor region 21;

(D) an anode electrode unit 31 made of a conductive material layer and formed so as to extend from on each unit phosphor region 21 to on barrier ribs 23;

(E) a resistor layer 33 for electrically connecting adjacent anode electrode units 31 to each other; and

(F) a feeding section 41 having a projection-depression shape for connecting an anode electrode unit 31A situated at an outermost peripheral part of the anode panel AP to an anode electrode control circuit 53.

One pixel is formed by a red light emitting unit phosphor region 21R, a green light emitting unit phosphor region 21G, and a blue light emitting unit phosphor region 21B. One subpixel is formed by a unit phosphor region 21. Each unit phosphor region is surrounded by barrier ribs 23. The plan shape of a part surrounding a unit phosphor region in the lattice-shaped barrier ribs 23 (which part corresponds to an inside contour line of a projection image of side surfaces of barrier ribs and is a kind of opening region 23B) is a rectangular shape (rectangle). Such plan shapes (plan shapes of opening regions 23B) are arranged in the form of a two-dimensional matrix (more specifically a grid), whereby the lattice-shaped barrier ribs are formed. In order to prevent color turbidity, or optical crosstalk of a displayed image, a light absorbing layer (black matrix) 22 is formed between a unit phosphor region 21 and a unit phosphor region 21 and between a barrier rib 23 and the substrate 20. A spacer (not shown) made of alumina (Al₂O₃, a purity of 99.8% by weight) is disposed between the cathode panel CP and the anode panel AP.

FIG. 3A schematically shows an example of an arrangement of barrier ribs 23 and unit phosphor regions 21. Incidentally, in FIG. 3A, the unit phosphor regions 21, the feeding section 41, and a feeding point 44 are hatched to clearly show components of the anode panel AP. The number and the arrangement of the unit phosphor regions 21 in FIG. 3A are for the purpose of description and are thus different from those of an actual display device. FIG. 3B is a partially cutaway schematic perspective view of barrier ribs and unit phosphor regions.

In the anode panel AP for the flat-panel display device and the display device according to the first example or the second example to be described later, as shown in the schematic partial end view of FIG. 1 or FIG. 2 showing the feeding section and the like, and as shown in the schematic partial plan view of FIG. 4 or FIG. 5 showing the feeding section and the like, the feeding section 41 has a projection-depression shape, a feeding section conductive material layer 42 is formed in a feeding section depression part 41B, and a feeding section resistor layer 43 for electrically connecting feeding section conductive material layers 42 formed in adjacent depression parts 41B in the feeding section 41 to each other is formed on a feeding section projection part 41A. Further, an anode electrode unit 31A situated at an outermost peripheral part of the anode panel AP and a feeding section conductive material layer 42 formed in a depression part 41B of the feeding section 41 which depression part is adjacent to the anode electrode unit 31A are connected to each other by a feeding section resistor layer 43.

As shown in FIG. 4 or FIG. 5, the plan shape of a set of anode electrode units (anode electrode units 31 arranged in the form of a two-dimensional matrix) is a rectangular shape, and main parts of feeding section depression parts 41B and main parts of feeding section projection parts 41A extend substantially in parallel with sides of this rectangle. A main part of a feeding section projection part 41A and a main part of a feeding section projection part 41A adjacent to each other are separated by a feeding section depression part 41B. The main part of the feeding section projection part 41A and the main part of the feeding section projection part 41A adjacent to each other are connected by a part of the feeding section projection parts 41A which part extends substantially perpendicularly or obliquely with respect to a side of the rectangle. Incidentally, in FIG. 4 and FIG. 5, the barrier ribs 23, the resistor layer 33, the feeding section projection parts 41A, and the feeding section resistor layer 43 are hatched to clearly show components of the anode panel AP.

The feeding section conductive material layer 42 formed in a part of the depression parts 41B of the feeding section 41 extends to the feeding point 44. The feeding section 41 is connected to the feeding point 44, and further connected to the anode electrode control circuit 53 via wiring not shown in the figures. Incidentally, it is generally desirable that a resistor R₀ (see FIG. 1 and FIG. 2) for preventing overcurrent and electric discharge be disposed between the anode electrode control circuit 53 and the feeding point 44. The resistance value of the resistor R₀ is preferably within a range of 0.1 kΩ to 100 kΩ, and is specifically 10 kΩ, for example.

In the display device according to the first example, the cathode electrode 11 is connected to a cathode electrode control circuit 51, the gate electrode 13 is connected to a gate electrode control circuit 52, and the anode electrode units 31 are connected to the anode electrode control circuit 53 via the feeding section 41. These control circuits can be formed by well known circuits. During actual operation of the display device, an output voltage V_{A} of the anode electrode control circuit 53 is generally constant, and can be 5 kilovolts to 15 kilovolts, for example. On the other hand, during actual operation of the display device, any of the following methods may be used for a voltage V_{C} applied to the cathode electrode 11 and a voltage V_{G} applied to the gate electrode 13:

(1) a method of setting the voltage V_{C} applied to the cathode electrode 11 constant and changing the voltage V_{G} applied to the gate electrode 13,

(2) a method of changing the voltage V_{C} applied to the cathode electrode 11 and setting the voltage V_{G} applied to the gate electrode 13 constant, and

(3) a method of changing the voltage V_{C} applied to the cathode electrode 11 and changing the voltage V_{G} applied to the gate electrode 13.

During actual operation of the display device, a relatively negative voltage is applied from the cathode electrode control circuit 51 to the cathode electrode 11, a relatively positive voltage is applied from the gate electrode control circuit 52 to the gate electrode 13, and a positive voltage even higher than the voltage applied to the gate electrode 13 is applied from the anode electrode control circuit 53 to the anode electrode units 31. When the display device makes display, for example, a scanning signal is input from the cathode electrode control circuit 51 to the cathode electrode 11, and a video signal is input from the gate electrode control circuit 52 to the gate electrode 13. Incidentally, a video signal may be input from the cathode electrode control circuit 51 to the cathode electrode 11, and a scanning signal may be input from the gate electrode control circuit 52 to the gate electrode 13. Due to an electric field generated when a voltage is applied between the cathode electrode 11 and the gate electrode 13, electrons are emitted from the electron emission part 15 or 15A on the basis of a quantum tunneling effect. The electrons are attracted to the anode electrode unit 31, pass through the anode electrode unit 31, and then collide with the unit phosphor region 21. As a result, the unit phosphor region 21 is excited to emit light, and thereby a desired image can be obtained. That is, the operation of the display device is basically controlled by the voltage V_{G} applied to the gate electrode 13 and the voltage V_{C} applied to the cathode electrode 11.

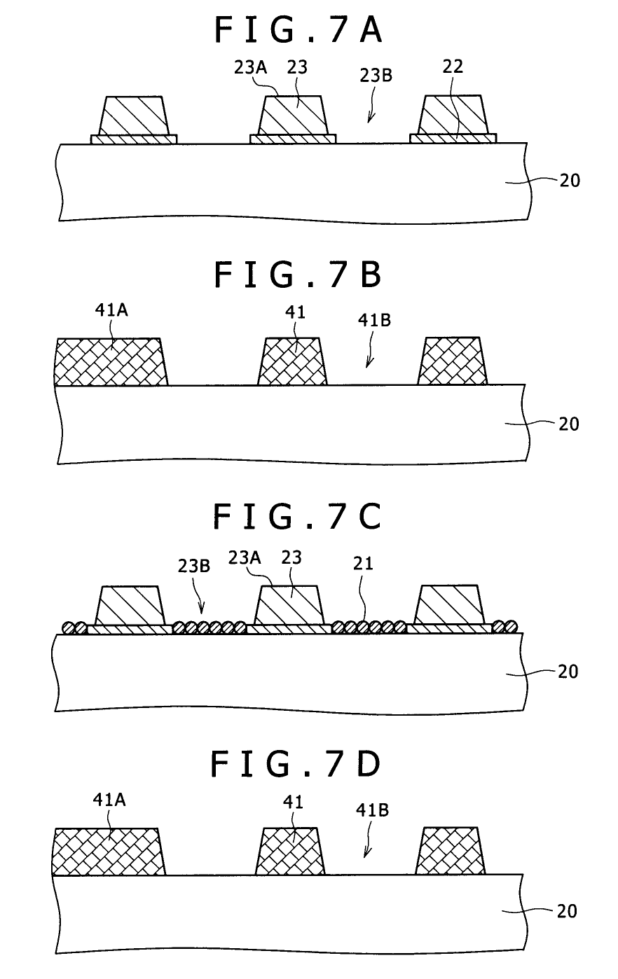

A method of manufacturing the anode panel for the flat-panel display device and a method of manufacturing the flat-panel display device according to the first example of the present invention will be described below with reference to FIGS. 7A to 7D, FIG. 8, FIG. 9, FIGS. 10A and 10B, FIG. 11, FIG. 12, FIGS. 13A and 13B, FIGS. 14A and 14B, FIGS. 15A to 15D, FIG. 16, and FIG. 17.

[Step 100]

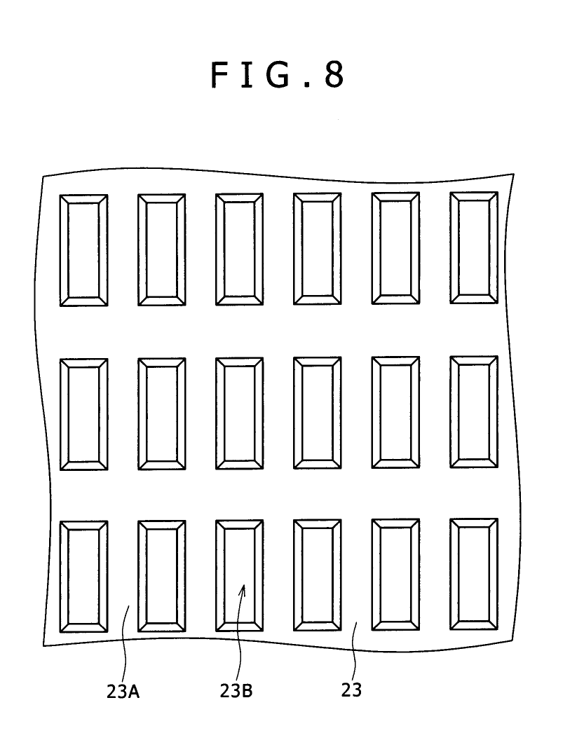

First, lattice-shaped barrier ribs 23 are formed on a substrate 20, and a feeding section 41 having a projection-depression shape is simultaneously formed on the substrate 20. Specifically, a lead glass layer colored black with a metal oxide such as cobalt oxide or the like is formed so as to have a thickness of about 50 μm. Thereafter the lead glass layer is selectively processed by a photolithography technique and an etching technique. Thereby the lattice-shaped barrier ribs 23 (see a schematic partial end view of FIG. 7A and a schematic partial plan view of FIG. 8) are formed, and the feeding section 41 having the projection-depression shape (formed by feeding section projection parts 41A and feeding section depression parts 41B) is simultaneously formed (see a schematic partial end view of FIG. 7B). Incidentally, in some cases, the barrier ribs 23 and the feeding section 41 may be formed by printing a glass paste having a low melting point on the substrate 20 by a screen printing method and then firing the glass paste having a low melting point, or the barrier ribs 23 and the feeding section 41 may be formed by forming a photosensitive polyimide resin layer on the entire surface of the substrate 20, then exposing the photosensitive polyimide resin layer to light and developing the photosensitive polyimide resin layer. The size of an opening region 23B of the barrier ribs 23 is about 280 μm long by 100 μm wide by 60 μm high. Incidentally, it is desirable that before the formation of the barrier ribs 23, a light absorbing layer (black matrix) 22 composed of chromium oxide, for example, be formed on the surface of a part of the substrate 20 over which part the barrier ribs 23 are to be formed. Incidentally, reference numeral 23A denotes a barrier rib top surface.

[Step 110]

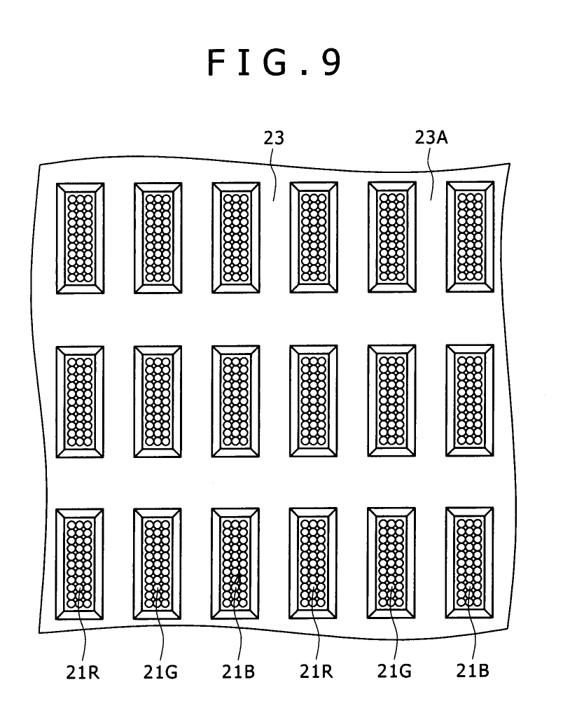

Next, unit phosphor regions 21 are formed on parts of the substrate 20 which parts are surrounded by the barrier ribs 23. Specifically, to form a red light emitting unit phosphor region 21R, a red light emitting phosphor slurry prepared by for example dispersing red light emitting phosphor particles in a polyvinyl alcohol (PVA) resin and water and further adding ammonium bichromate is applied to the entire surface. Then the red light emitting phosphor slurry is dried. Thereafter, the red light emitting phosphor slurry is exposed to light by irradiating a part of the red light emitting phosphor slurry which part is to form the red light emitting unit phosphor region 21R with ultraviolet rays from the substrate 20 side. The red light emitting phosphor slurry is gradually cured from the substrate 20 side. The thickness of the formed red light emitting unit phosphor region 21R is determined by an amount of irradiation of the red light emitting phosphor slurry with ultraviolet rays. In this case, for example, the red light emitting unit phosphor region 21R has a thickness of about 8 μm, which is attained by adjusting a time of irradiation of the red light emitting phosphor slurry with the ultraviolet rays. Then, the red light emitting phosphor slurry is developed, whereby the red light emitting unit phosphor region 21R can be formed between predetermined barrier ribs 23. Thereafter, a green light emitting phosphor slurry is similarly treated to form a green light emitting unit phosphor region 21G. Further, a blue light emitting phosphor slurry is similarly treated to form a blue light emitting unit phosphor region 21B. Thus, a structure shown in the schematic partial end view of FIG. 7C and in the schematic partial plan view of FIG. 9 can be obtained. The method of forming the unit phosphor regions is not limited to the above-described method. Each unit phosphor region may be formed by sequentially applying a red light emitting phosphor slurry, a green light emitting phosphor slurry, and a blue light emitting phosphor slurry, and thereafter sequentially exposing and developing the phosphor slurries. Alternatively, each unit phosphor region may be formed by a screen printing method or the like. Incidentally, no unit phosphor region is formed in the feeding section 41, and therefore the structure of the feeding section 41 is as shown in the schematic partial end view of FIG. 7D.

[Step 120]

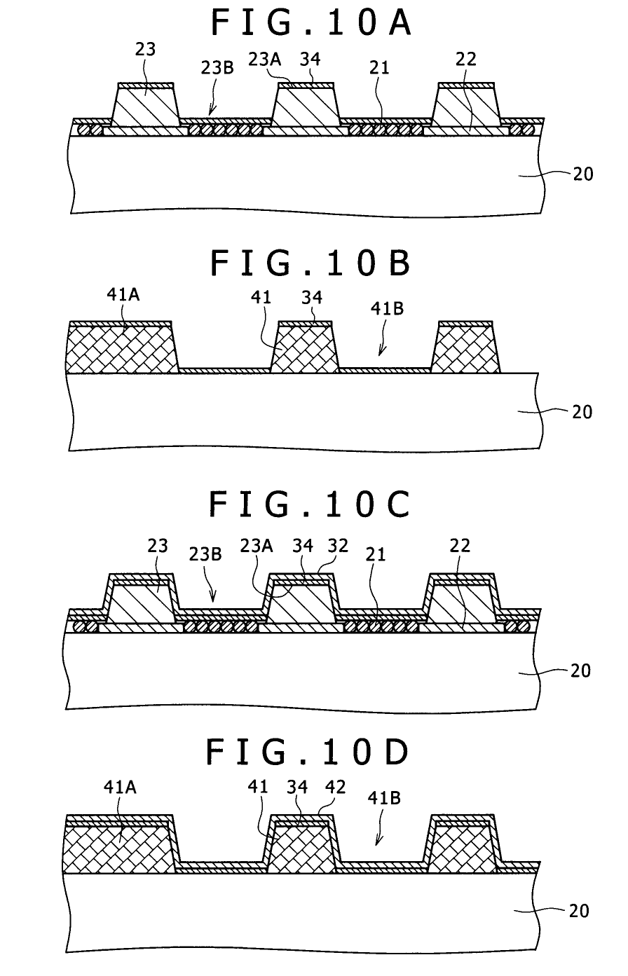

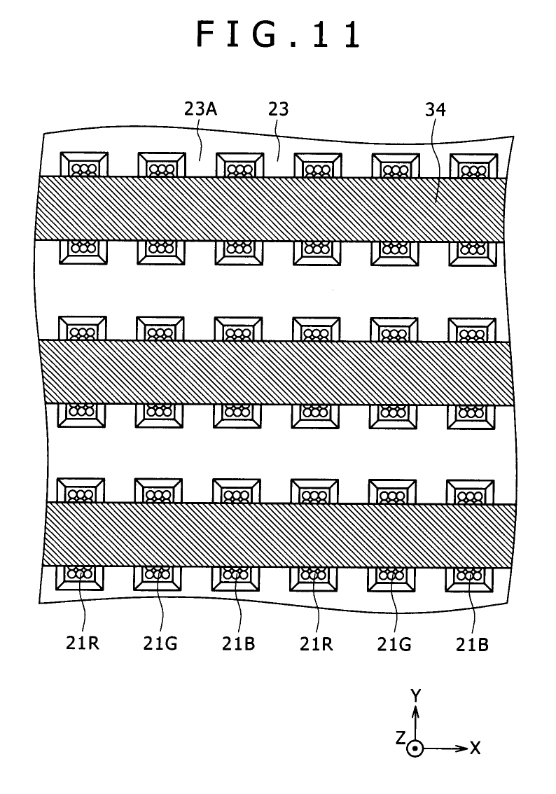

Thereafter a resin layer 34 is formed on barrier rib top surfaces 23A and the unit phosphor regions 21, and at the same time, the resin layer 34 is formed on the feeding section projection parts 41A (and the feeding section depression parts 41B in the first example). Specifically, the resin layer 34 can be formed by a metal mask printing method or a screen printing method in which a metal mask or a mesh screen mask having openings substantially coinciding with a formation pattern of the resin layer 34 is prepared, an acrylic lacquer, for example, is put on the mask, and the acrylic lacquer on the mask is printed by a squeegee on the barrier rib top surfaces 23A and the unit phosphor regions 21 as well as the feeding section projection parts 41A and the feeding section depression parts 41B through the openings. Incidentally, in this case, the resin layer is applied (printed) on the barrier rib top surfaces 23A and the unit phosphor regions 21 in parallel with a shorter side of the rectangle as the plan shape of a part surrounding a unit phosphor region in the lattice-shaped barrier ribs 23 (X-direction in FIG. 11) with a width narrower than a longer side of the rectangle. This state is shown in the schematic partial end views of FIGS. 10A and 10B and the schematic partial plan view of FIG. 11. Appropriate adjustment of viscosity or the like of the applied (printed) resin layer 34 can set the resin layer 34 in a state of covering the barrier rib top surfaces 23A and the unit phosphor regions 21 as well as the feeding section projection parts 41A and the feeding section depression parts 41B but not covering the side surfaces of the barrier ribs 23 and the side surfaces of the feeding section 41 (or thinly covering the side surfaces of the barrier ribs 23 and the side surfaces of the feeding section 41 if the side surfaces of the barrier ribs 23 and the side surfaces of the feeding section 41 are covered).

Next, the resin layer 34 is dried. Specifically, the substrate 20 is brought into a drying furnace and dried at a predetermined temperature. The drying temperature for the resin layer 34 is preferably in a range of 50° C. to 90° C., for example. A drying time for the resin layer 34 is preferably in a range of a few minutes to a few ten minutes, for example. Of course, the drying time is decreased or increased as the drying temperature is raised or lowered.

Alternatively, the resin layer 34 can be formed by a method described in the following. The substrate 20 having the barrier ribs 23 and the unit phosphor regions 21 formed thereon is immersed in a liquid (specifically water) filled in a treatment vessel such that the unit phosphor regions 21 face a liquid surface side. Incidentally, a drain part of the treatment vessel is closed in advance. Then, a resin layer 34 having a substantially flat surface is formed on the liquid surface. Specifically, an organic solvent in which a resin (lacquer) for forming the resin layer 34 is dissolved is dropped on the liquid surface. That is, a resin layer material for forming the resin layer 34 is spread on the liquid surface. The resin (lacquer) for forming the resin layer 34 is a kind of varnish in a broad sense, and includes a composition including a cellulose derivative, generally nitrocellulose as a main component which composition is dissolved in a volatile solvent such as a lower fatty acid ester, urethane lacquers including other synthetic polymers, and acrylic lacquers. Then, the resin layer material is dried for about two minutes, for example, in a state of being floated on the liquid surface. Thereby a film of the resin layer material is formed, and the resin layer 34 is flatly formed on the liquid surface. When the resin layer 34 is formed, an amount of the resin layer material being spread is adjusted such that the resin layer 34 has a thickness of about 30 nm, for example. Then, the drain part of the treatment vessel is opened, and the liquid is drained from the treatment vessel to lower the liquid surface, whereby the resin layer 34 formed on the liquid surface moves toward the barrier ribs 23, the resin layer 34 comes in contact with the barrier ribs 23, and finally the resin layer 34 comes into contact with the unit phosphor regions 21. The resin layer 34 is left on the unit phosphor regions 21 and the barrier ribs 23.

[Step 130]

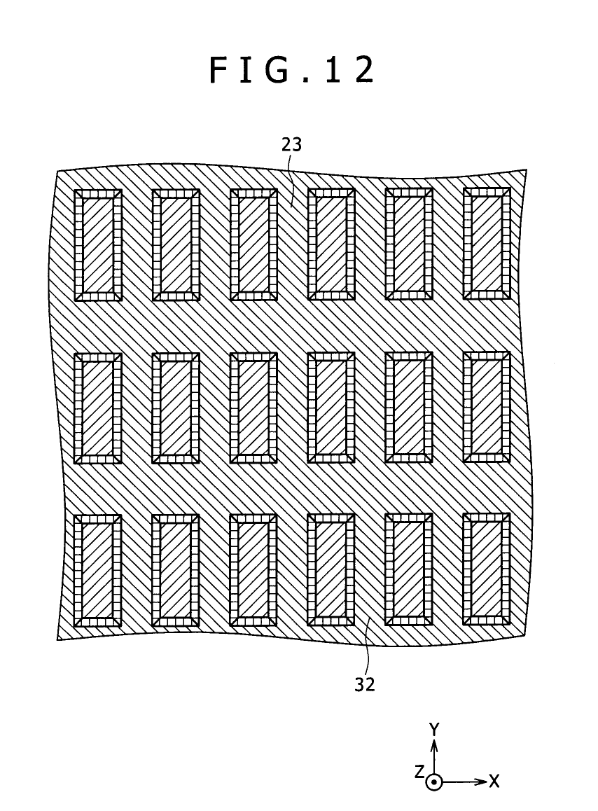

Thereafter a conductive material layer 32 is formed on the entire surface (specifically on the resin layer 34 and the barrier ribs 23), and at the same time, a feeding section conductive material layer 42 is formed on the entire surface of the feeding section 41. Specifically, the conductive material layer 32 and the feeding section conductive material layer 42 made of a conductive material such for example as aluminum (Al) is formed so as to cover the resin layer 34, the barrier ribs 23, and the feeding section 41 by various deposition methods or a sputtering method (see the schematic partial end views of FIGS. 10C and 10D and the schematic partial plan view of FIG. 12). The thickness of the conductive material layer 32 and the feeding section conductive material layer 42 over the substrate 20 is 0.15 μm, for example.

[Step 140]

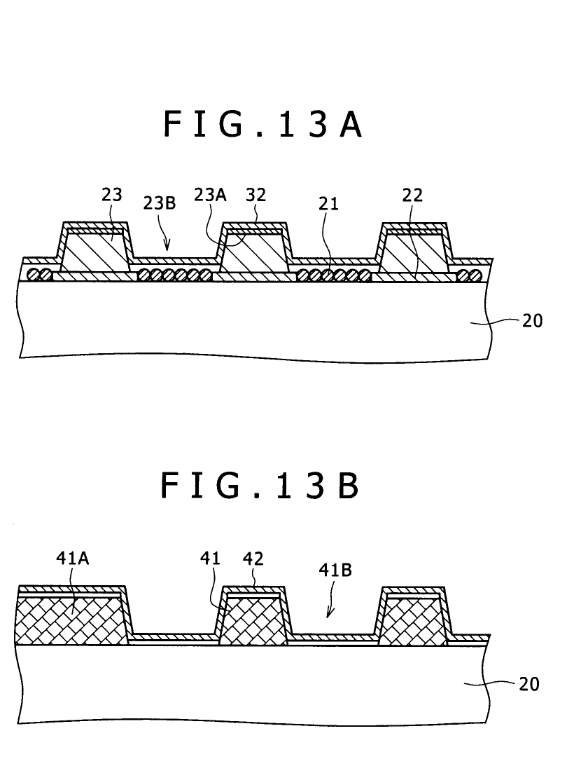

Next, the resin layer 34 is removed by performing heat treatment. Specifically, the resin layer 34 is fired at about 400° C. (see the schematic partial end views of FIGS. 13A and 13B). This firing process burns off the resin layer 34, the conductive material layer 32 remaining on the unit phosphor regions 21 and the barrier ribs 23, and the feeding section conductive material layer 42 remaining on the feeding section projection parts 41A and the feeding section depression parts 41B. A gas generated by the combustion of the resin layer 34 is for example discharged to an outside through minute holes formed in a region of the conductive material layer 32 and the feeding section 41 which region is bent along the shape of the barrier ribs 23 and the feeding section 41. Since the holes are minute, the holes do not have any serious effects on the structural strength of the anode electrode units 31 and the feeding section 41 or on image display characteristics.

[Step 150]

Thereafter parts of the conductive material layer 32 which parts are situated on the barrier rib top surfaces 23A are removed to obtain anode electrode units 31 formed so as to extend from on each unit phosphor region 21 to on the barrier ribs 23. At the same time, parts of the feeding section conductive material layer 42 which parts are situated on the feeding section projection parts 41A are removed.

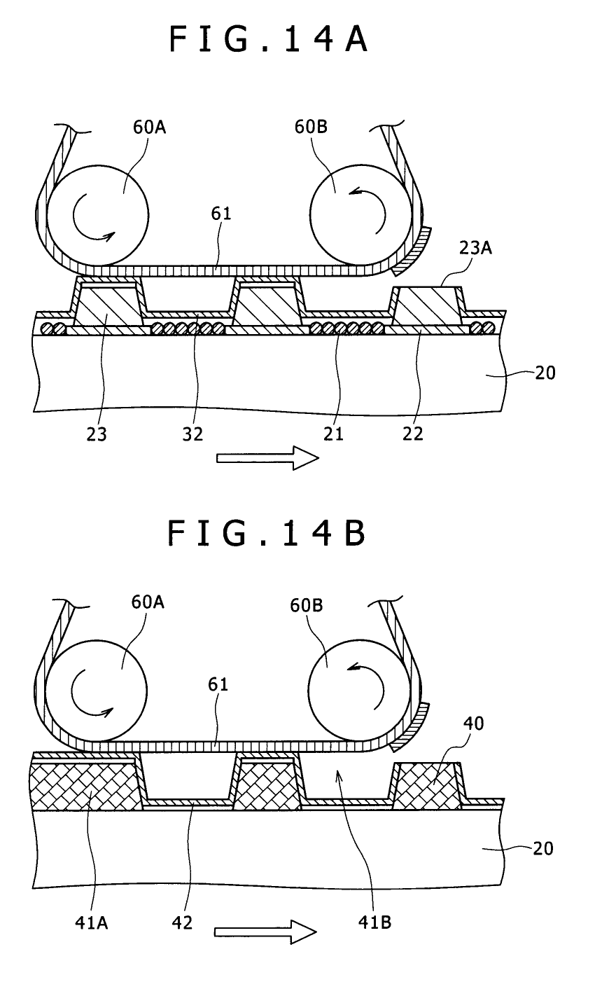

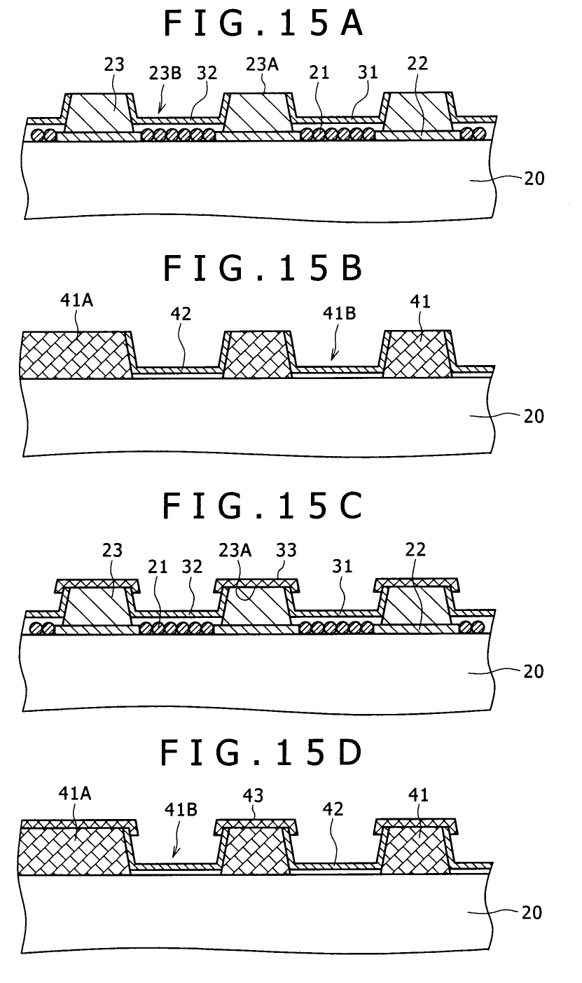

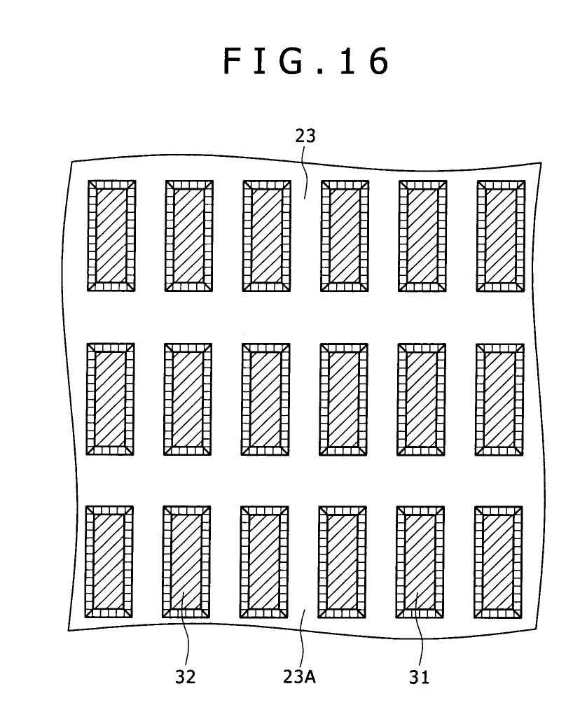

Specifically, for example, using a so-called dry film laminator, a peeling member 61 is bonded to parts of the conductive material layer 32 which parts are situated on the barrier rib top surfaces 23A. Thereafter the peeling member 61 is mechanically peeled off to remove the parts of the conductive material layer 32 which parts are situated on the barrier rib top surfaces 23A (see the schematic partial end view of FIG. 14A). Meanwhile, the peeling member 61 is bonded to parts of the feeding section conductive material layer 42 which parts are situated on the feeding section projection parts 41A. Thereafter the peeling member 61 is mechanically peeled off to remove the parts of the feeding section conductive material layer 42 which parts are situated on the feeding section projection parts 41A (see the schematic partial end view of FIG. 14B). Thereby, the barrier rib top surfaces 23A and the feeding section projection parts 41A are exposed. The peeling member 61 includes: a cohesive layer or an adhesive layer made of an acrylic ester copolymer, a methacrylate copolymer, or a polymer material obtained by adding a softener or the like to a main component such as a silicon rubber or the like; and a retaining film (for example a polyethylene terephthalate film, a polyimide film or the like) for retaining the cohesive layer or the adhesive layer. Using a roller 60A, the cohesive layer or the adhesive layer forming the peeling member 61 is pressure-bonded to the parts of the conductive material layer 32 which parts are situated on the barrier rib top surfaces 23A and the parts of the feeding section conductive material layer 42 which parts are situated on the feeding section projection parts 41A. Then, using a roller 60B, the peeling member 61 is mechanically peeled off. It is desirable that the peeling member 61 be mechanically peeled off along a direction parallel with a longer side of the rectangle as the plan shape of a part surrounding a unit phosphor region in the lattice-shaped barrier ribs 23 (Y-direction in FIG. 12). Thus, a structure shown in the schematic partial end views of FIGS. 15A and 15B and in the schematic partial plan view of FIG. 16 can be obtained.

[Step 160]

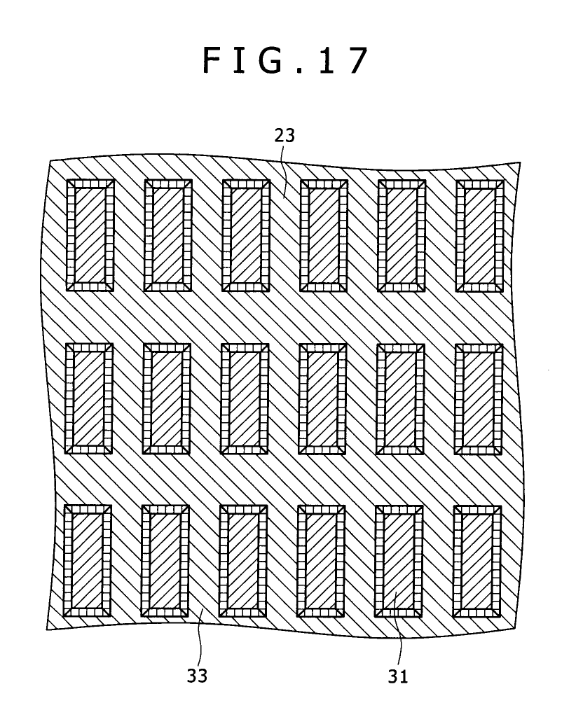

Thereafter a resistor layer 33 for electrically connecting adjacent anode electrode units 31 to each other is formed, and at the same time, a feeding section resistor layer 43 for electrically connecting feeding section conductive material layers 42 formed in adjacent depression parts 41B (feeding section depression parts 41B) of the feeding section 41 to each other is formed on feeding section projection parts 41A. Specifically, for example, on the basis of a method exemplified by various PVD methods and CVD methods, a screen printing method, a metal mask printing method, and an application method using a roll coater, the resistor layer 33 composed of SiC is formed so as to extend from a barrier rib top surface 23A to halfway points on barrier rib side surfaces, and the feeding section resistor layer 43 composed of SiC is formed so as to extend from a feeding section projection part 41A to halfway points on feeding section side surfaces. Thus, a structure shown in the schematic partial end views of FIGS. 15C and 15D and in the schematic partial plan view of FIG. 17 can be obtained. Incidentally, an anode electrode unit 31A situated at an outermost peripheral part of the anode panel AP and the feeding section conductive material layer 42 formed in a depression part 41B of the feeding section 41 which depression part is adjacent to the anode electrode unit 31A are connected to each other by the feeding section resistor layer 43.

The anode panel AP can be completed as a result of the above steps.

[Step 170]

A cathode panel CP having electron emission elements formed therein is prepared. A method of manufacturing an electron emission element will be described later. Then, a display is assembled. Specifically, for example, a spacer (not shown) is attached on a spacer holding part (not shown) provided in the effective region of the anode panel AP. The anode panel AP and the cathode panel CP are arranged such that the unit phosphor regions 21 and the electron emission elements face each other. The anode panel AP and the cathode panel CP (more specifically the substrate 20 and the support 10) are bonded to each other at peripheral parts thereof via a frame 24 made of ceramic or glass and having a height of about 1 mm. In the bonding, a frit glass is applied to parts for bonding the frame 24 and the anode panel AP to each other and parts for bonding the frame 24 and the cathode panel CP to each other. The anode panel AP, the cathode panel CP, and the frame 24 are attached to each other. The frit glass is dried by preliminary firing, and then fully fired at about 450° C. for 10 to 30 minutes. Thereafter, a space surrounded by the anode panel AP, the cathode panel CP, the frame 24 and the frit glass (not shown) is evacuated through a through hole (not shown) and a tip tube (not shown). When the pressure of the space reaches about 10⁻⁴ Pa, the tip tube is sealed by heating fusion. Thus, the space surrounded by the anode panel AP, the cathode panel CP, and the frame 24 can be evacuated. Alternatively, for example, the frame 24, the anode panel AP, and the cathode panel CP may be bonded together in a high-vacuum atmosphere. Alternatively, depending upon the structure of the display device, the anode panel AP and the cathode panel CP may be bonded to each other by an adhesive layer alone without the frame. Thereafter wiring connection to a necessary external circuit is performed, whereby the display device is completed.

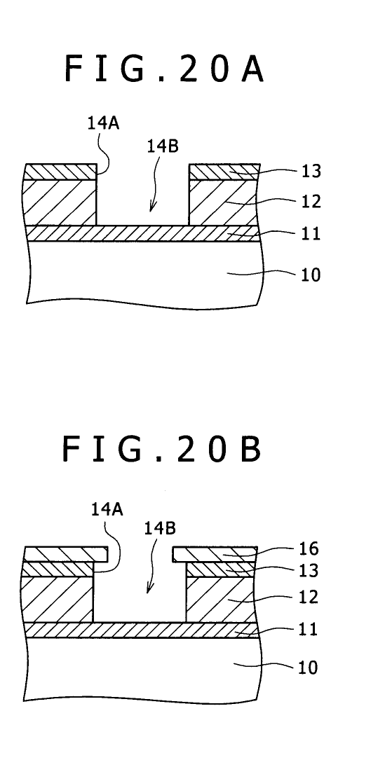

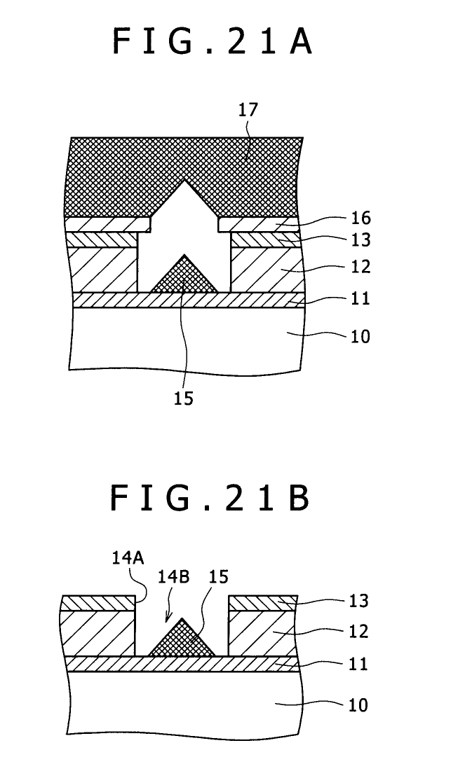

A method of manufacturing a Spindt-type field emission element will be described below with reference to FIGS. 20A and 20B and FIGS. 21A and 21B which are schematic partial end views of a support 10 and the like forming a cathode panel.

This Spindt-type field emission element can basically be obtained by a method of forming a conical-shaped electron emission part 15 by vertical vapor deposition of a metal material. Specifically, while deposition particles perpendicularly enter a first opening portion 14A formed in a gate electrode 13, an amount of deposition particles reaching the bottom part of a second opening portion 14B is gradually decreased by utilizing a masking effect produced by an overhanging deposit formed around an opening edge of the first opening portion 14A, so that the electron emission part 15, which is a conical-shaped deposit, is formed on a self-alignment basis. Description below will be made of a method in which a peeling layer 16 is formed on the gate electrode 13 and the insulating layer 12 in advance to make it easy to remove an unnecessary overhanging deposit. Incidentally, in the drawings for the description of the method of manufacturing the field emission element, one electron emission part is shown.

[Step A0]

A film of a conductive material layer composed of polysilicon, for example, for a cathode electrode is formed on a support 10 composed of a glass substrate, for example, by a plasma CVD method. Then, the conductive material layer for the cathode electrode is patterned by a lithography technique and a dry etching technique to form the cathode electrode 11 in a stripe shape. Thereafter, an insulating layer 12 composed of SiO₂ is formed on the entire surface by a CVD method.

[Step A1]

Next, a film of a conductive material layer (for example a TiN layer) for a gate electrode is formed on the insulating layer 12 by a sputtering method. Then, the conductive material layer for the gate electrode is patterned by a lithography technique and a dry etching technique to form the gate electrode 13 in a stripe shape. The cathode electrode 11 in the stripe shape extends in a horizontal direction with respect to the paper surface of the drawing, and the gate electrode 13 in the stripe shape extends in a direction perpendicular to the paper surface of the drawing.

The gate electrode 13 can be formed by a publicly known thin film forming method such as a PVD method including a vacuum deposition method and the like, a CVD method, a plating method including an electroplating method and an electroless plating method, a screen printing method, a laser ablation method, a sol-gel method, a lift-off method and the like, or a combination of one of these methods with an etching technique as required. For example, the gate electrode in the stripe shape can be directly formed by a screen printing method or a plating method.

[Step A2]

Thereafter a resist layer is formed again. A first opening portion 14A is formed in the gate electrode 13 by etching. Further, a second opening portion 14B is formed in the insulating layer. The cathode electrode 11 is exposed at the bottom part of the second opening portion 14B. The resist layer is thereafter removed. Thus, a structure shown in FIG. 20A can be obtained.

[Step A3]

Next, a peeling layer 16 is formed by oblique vapor deposition of nickel (Ni) on the gate electrode 13 and the insulating layer 12 while the support 10 is rotated (see FIG. 20B). At this time, the incidence angle of deposition particles with respect to a normal to the support 10 is selected to be sufficiently large (for example an incidence angle of 65 degrees to 85 degrees), whereby the peeling layer 16 can be formed on the gate electrode 13 and the insulating layer 12 with nickel hardly deposited at the bottom part of the second opening portion 14B. The peeling layer 16 extends from the opening edges of the first opening portion 14A in a shape of eaves. Thereby the diameter of the first opening portion 14A is decreased in effect.

[Step A4]

Next, molybdenum (Mo) as an electrically conductive material, for example, is deposited on the entire surface by vertical vapor deposition (an incidence angle of three degrees to 10 degrees). At this time, as shown in FIG. 21A, as a conductive member layer 17 having an overhanging shape grows on the peeling layer 16, the substantial diameter of the first opening portion 14A is gradually decreased. Therefore deposition particles contributing to the deposition at the bottom part of the second opening portion 14B are gradually limited to particles that pass around the central region of the first opening portion 14A. As a result, a conical-shaped deposit is formed at the bottom part of the second opening portion 14B. This conical-shaped deposit constitutes the electron emission part 15.

[Step A5]

Then, as shown in FIG. 21B, the peeling layer 16 is peeled off from the surfaces of the gate electrode 13 and the insulating layer 12 by a lift-off method, so that the conductive member layer 17 above the gate electrode 13 and the insulating layer 12 are selectively removed. Thus, the cathode panel having a plurality of Spindt-type field emission elements can be obtained.

In the first example, alternatively,

(1) the steps may be performed in order of [step 100], [step 110], [step 120], [step 130], [step 150], [step 140], [step 160], and [step 170],

(2) the steps may be performed in order of [step 100], [step 110], [step 120], [step 130], [step 150], [step 160], [step 140], and [step 170],

(3) the steps may be performed in order of [step 100], [step 110], [step 160], [step 120], [step 130], [step 140], [step 150], and [step 170],

(4) the steps may be performed in order of [step 100], [step 110], [step 160], [step 120], [step 130], [step 150], [step 140], and [step 170],

(5) the steps may be performed in order of [step 100], [step 160], [step 110], [step 120], [step 130], [step 140], [step 150], and [step 170], or

(6) the steps may be performed in order of [step 100], [step 160], [step 110], [step 120], [step 130], [step 150], [step 140], and [step 170].

The anode electrode units in the display device according to the first example are formed by a physical method of mechanically peeling the peeling member 61, or a so-called dry process, rather than being formed by a so-called wet process. Therefore, there is no fear of damage being caused to the unit phosphor regions. In addition, since the feeding section has a projection-depression shape, the area of parts of the feeding section which parts face the cathode panel can be further decreased, and discharge between the feeding section and the electron emission elements can be further reduced. As a result, it is possible to provide a flat-panel display device having high display quality and highly stable operation characteristics. Further, since the anode electrode is formed so as to be divided into anode electrode units having a smaller area, capacitance between the anode electrode units and the electron emission elements can be decreased, and generated energy can be reduced. It is therefore possible to effectively prevent occurrence, sustainment, and growth of an abnormal discharge (vacuum arc discharge) between the anode electrode units and the electron emission elements. In addition, since the resistor layer is formed between an anode electrode unit and an anode electrode unit, discharge between the anode electrode units can be suppressed reliably. It is therefore possible to reliably prevent occurrence of local damage to anode electrode units due to discharge. Further, since the peripheral part of the set of the anode electrode units is connected to the anode electrode control circuit via the feeding section, there is no fear of voltage applied from the anode electrode control circuit being decreased depending on the position of the anode electrode unit.

Relation between the size of an anode electrode unit and a discharge damage ratio was investigated. Specifically, an anode panel having an anode panel AP fabricated on the basis of the first example (an anode electrode unit is of such a size as to surround a unit phosphor region) was fabricated, and a display device was assembled. In addition, for comparison, anode panels in which the size of an anode electrode unit is one pixel (of such a size as to surround three subpixels as three unit phosphor regions), 12 pixels (4×3 pixels), and 42 pixels (7×6 pixels), respectively, and an anode panel having a non-divided anode electrode were fabricated on the basis of conventional methods, and display devices were assembled. Then, a large number of spots on the anode electrode units or the anode electrode of each anode panel were irradiated with a laser. As a result, a part of the anode electrode units or the anode electrode evaporated, projection parts and the like were formed, and thus the anode electrode units or the anode electrode was in an easily discharging state. When such display devices were operated, discharge occurred at spots irradiated with the laser. The following Table 3 shows a result indicating, in percentage terms, ratios of the number of spots damaged by discharge (damage or injury in the anode electrode units or the anode electrode in that bright spots do not appear when the display device was operated) to the number of spots irradiated with the laser. The discharge damage ratio of the first example was 0%.

TABLE 3

| | Size of anode | Discharge |
|---|---|---|
| | electrode unit | damage ratio |
| First example | One subpixel | 0% |
| | One pixel | 30% |
| | 12 pixels | 50% |
| | 42 pixels | 85% |
| | No division | 100% |

### Second Example

A second example relates to a method of manufacturing an anode panel for a flat-panel display device according to a second embodiment of the present invention (more specifically a second-A embodiment of the present invention), a method of manufacturing a flat-panel display device according to the second embodiment of the present invention (more specifically the second-A embodiment of the present invention), a method of manufacturing an anode panel for a flat-panel display device according to the third embodiment of the present invention (more specifically a third-B embodiment of the present invention), a method of manufacturing a flat-panel display device according to the third embodiment of the present invention (more specifically the third-B embodiment of the present invention), and an anode panel for a flat-panel display device and a flat-panel display device according to the present invention.

The constitutions and structures of a display device, an anode panel AP, and a cathode panel according to the second example and the constitutions and structures of barrier ribs, a feeding section, electron emission elements and the like can be made to be the same as in the first example, and therefore detailed description thereof will be omitted.

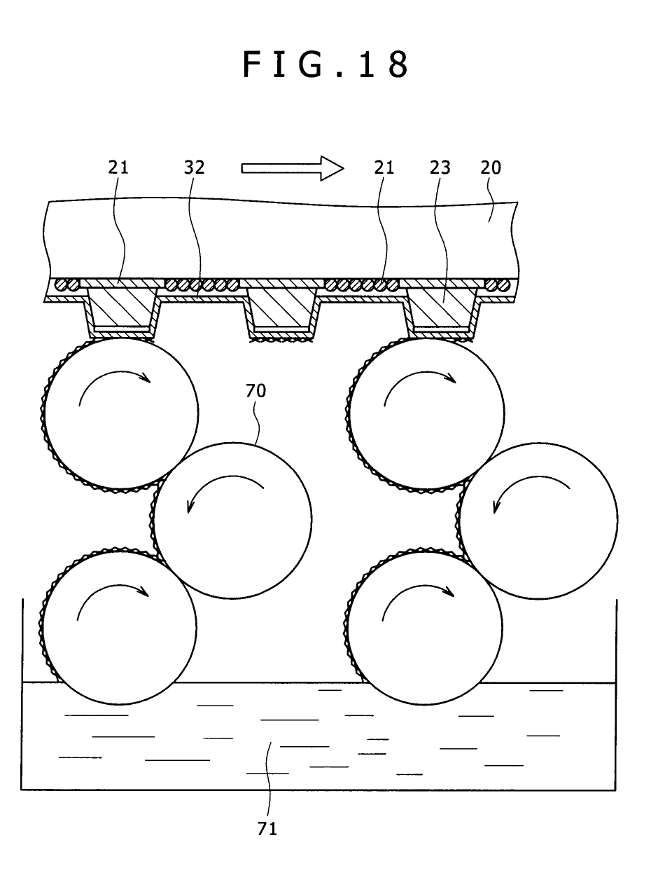

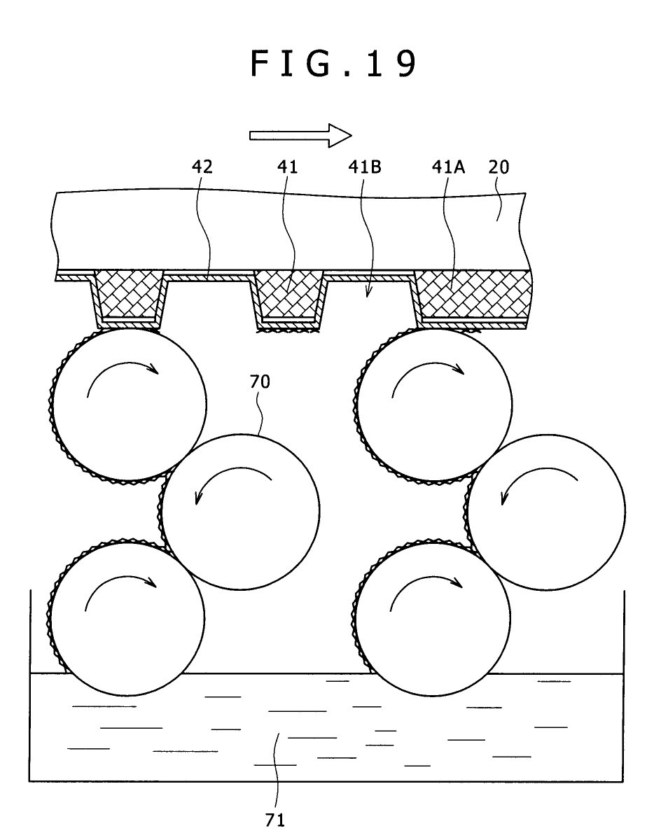

The method of manufacturing the anode panel for the flat-panel display device according to the second example, and the method of manufacturing the flat-panel display device will be described below with reference to FIG. 18 and FIG. 19.

[Step 200]

First, as in [step 100] in the first example, lattice-shaped barrier ribs 23 are formed on a substrate 20, and at the same time, a feeding section 41 having a projection-depression shape is formed on the substrate 20. Then, as in [step 110] in the first example, unit phosphor regions 21 are formed on parts of the substrate 20 which parts are surrounded by the barrier ribs 23. Next, as in [step 120] in the first example, a resin layer 34 is formed on barrier rib top surfaces 23A and the unit phosphor regions 21, and at the same time, the resin layer 34 is formed on feeding section projection parts 41A (and feeding section depression parts 41B in the case of the first example). Then, as in [step 130] in the first example, a conductive material layer 32 is formed on the entire surface (specifically on the resin layer 34 and the barrier ribs 23), and at the same time, a feeding section conductive material layer 42 is formed on the entire surface of the feeding section 41. Thereafter, as in [step 140] in the first example, the resin layer 34 is removed by performing heat treatment.

[Step 210]

In [step 150] in the first example, parts of the conductive material layer 32 which parts are situated on the barrier rib top surfaces 23A are removed using the peeling member 61, and at the same time, parts of the feeding section conductive material layer 42 which parts are situated on the feeding section projection parts 41A are removed.

On the other hand, in the second example, as schematically shown in FIG. 18 and FIG. 19, this step of removing the parts of the conductive material layer 32 which parts are situated on the barrier rib top surfaces 23A and simultaneously removing the parts of the feeding section conductive material layer 42 which parts are situated on the feeding section projection parts 41A includes a step of removing the parts of the conductive material layer 32 which parts are situated on the barrier rib top surfaces 23A by applying an etchant 71 to the parts of the conductive material layer 32 which parts are situated on the barrier rib top surfaces 23A by a roll coater 70 with the conductive material layer 32 facing downward, and a step of removing the parts of the feeding section conductive material layer 42 which parts are situated on the feeding section projection parts 41A by applying the etchant 71 to the parts of the feeding section conductive material layer 42 which parts are situated on the feeding section projection parts 41A by the roll coater 70 with the feeding section conductive material layer 42 facing downward. Thus, the parts of the conductive material layer 32 which parts are situated on the barrier rib top surfaces 23A can be removed, and anode electrode units 31 formed so as to extend from on each unit phosphor region 21 to on the barrier ribs 23 can be obtained. At the same time, the parts of the feeding section conductive material layer 42 which parts are situated on the feeding section projection parts 41A can be removed. Incidentally, in FIG. 18 and FIG. 19, the etchant on the roll coater 70 is denoted by cross marks.

When the conductive material layer 32 and the feeding section conductive material layer 42 are composed of aluminum (Al), a mixed water solution including acetic acid and nitric acid may be used as the etchant 71. It is desirable that, for example, the application of the etchant 71 by the roll coater 70 be performed by a reverse coater with a plurality of (three) rolls so that the thickness of the etchant 71 applied in one application is reduced as much as possible. Incidentally, the IRHD hardness of the rolls forming the roll coater can be 20 to 80, for example. It is also desirable that immediately after completion of the application of the etchant and completion of etching of the conductive material layer 32 and the feeding section conductive material layer 42, water washing be performed by the roll coater formed by the three-roll reverse coater, for example, to remove the etchant, and further water washing by a spray method, for example, and drying using a hot air or a heater be performed.

[Step 220]

Thereafter, as in [step 160] in the first example, a resistor layer 33 for electrically connecting adjacent anode electrode units 31 to each other is formed, and at the same time, a feeding section resistor layer 43 for electrically connecting feeding section conductive material layers 42 formed in adjacent depression parts 41B (feeding section depression parts 41B) of the feeding section 41 to each other is formed on the feeding section projection parts 41A.

The anode panel AP can be completed as a result of the above steps.

[Step 230]

Then, as in [step 170] in the first example, a display device is assembled.

In the second example, alternatively,

(1) the steps may be performed in order of {step 100}, {step 110}, {step 120}, {step 130}, [step 210], {step 140}, {step 160}, and {step 170},

(2) the steps may be performed in order of {step 100}, {step 110}, {step 120}, {step 130}, [step 210], {step 160}, {step 140}, and {step 170},

(3) the steps may be performed in order of {step 100}, {step 110}, {step 160}, {step 120}, {step 130}, {step 140}, [step 210], and {step 170},

(4) the steps may be performed in order of {step 100}, {step 110}, {step 160}, {step 120}, {step 130}, [step 210], {step 140}, and {step 170},

(5) the steps may be performed in order of {step 100}, {step 160}, {step 110}, {step 120}, {step 130}, {step 140}, [step 210], and {step 170}, or

(6) the steps may be performed in order of {step 100}, {step 160}, {step 110}, {step 120}, {step 130}, [step 210], {step 140}, and {step 170}.

In this case, {step 100}, {step 110}, {step 120}, {step 130}, {step 140}, {step 160}, and {step 170} above denote a step similar to [step 100], a step similar to [step 110], a step similar to [step 120], a step similar to [step 130], a step similar to [step 140], a step similar to [step 160], and a step similar to [step 170].

The anode electrode units in the display device according to the second example are formed by a so-called wet process. However, since the etchant is not applied to parts other than the parts of the conductive material layer which parts are situated on the barrier rib top surfaces and parts other than the parts of the feeding section conductive material layer which parts are situated on the feeding section projection parts, there is no fear of damage being caused to the unit phosphor regions. In addition, since the feeding section has a projection-depression shape, the area of parts of the feeding section which parts face the cathode panel can be further decreased, and discharge between the feeding section and the electron emission elements can be further reduced. As a result, it is possible to provide a flat-panel display device having high display quality and highly stable operation characteristics. Further, since the anode electrode is formed so as to be divided into anode electrode units having a smaller area, capacitance between the anode electrode units and the electron emission elements can be decreased, and generated energy can be reduced. It is therefore possible to effectively prevent occurrence of an abnormal discharge (vacuum arc discharge) between the anode electrode units and the electron emission elements. In addition, since the resistor layer is formed between an anode electrode unit and an anode electrode unit, discharge between the anode electrode units can be suppressed reliably. It is therefore possible to reliably prevent occurrence of local damage to anode electrode units due to discharge. Further, since the peripheral part of the set of the anode electrode units is connected to the anode electrode control circuit via the feeding section, there is no fear of voltage applied from the anode electrode control circuit being decreased depending on the position of the anode electrode unit.

While the present invention has been described above on the basis of preferred examples, the present invention is not limited to these examples. The constitutions and structures of the anode panels, the cathode panels, the anode electrode units, the feeding sections, the display devices, and the electron emission elements described in the examples are illustrative, and can be changed as appropriate. In addition, the methods of manufacturing the anode panels, the cathode panels, the anode electrode units, the feeding sections, the display devices, and the electron emission elements are illustrative, and can be changed as appropriate. Further, various materials used in manufacturing the anode panels and the cathode panels are illustrative, and can be changed as appropriate. The display devices have been described by taking color display as an example, the display can be monochrome display.

While in the first example and the second example, description has been made of the manufacturing method according to the first-A embodiment of the present invention and the manufacturing method according to the second-A embodiment of the present invention, it is needless to say that when a different structure or a different manufacturing method is employed for the feeding section 41, the methods of manufacturing anode electrode units as described in the first example and the second example can be applied to only the manufacture of anode electrode units. It is also needless to say that when a different structure or a different manufacturing method is employed for the anode electrode units, the methods of manufacturing a feeding section as described in the first example and the second example can be applied to only the manufacture of the feeding section.

In the embodiments of the present invention, a unit phosphor region emitting light of each color may be further divided. In this case, each of divided unit phosphor regions may be surrounded by barrier ribs, or a set of divided unit phosphor regions may be surrounded by barrier ribs.

In some cases, the anode electrode unit may be formed between the unit phosphor region and the substrate. Further, in the feeding section having the projection-depression shape, the feeding section conductive material layer may be formed on the entire surface of the feeding section. Incidentally, depression-shaped parts of the feeding section and projection-shaped parts of the feeding section may have a rounded pattern.

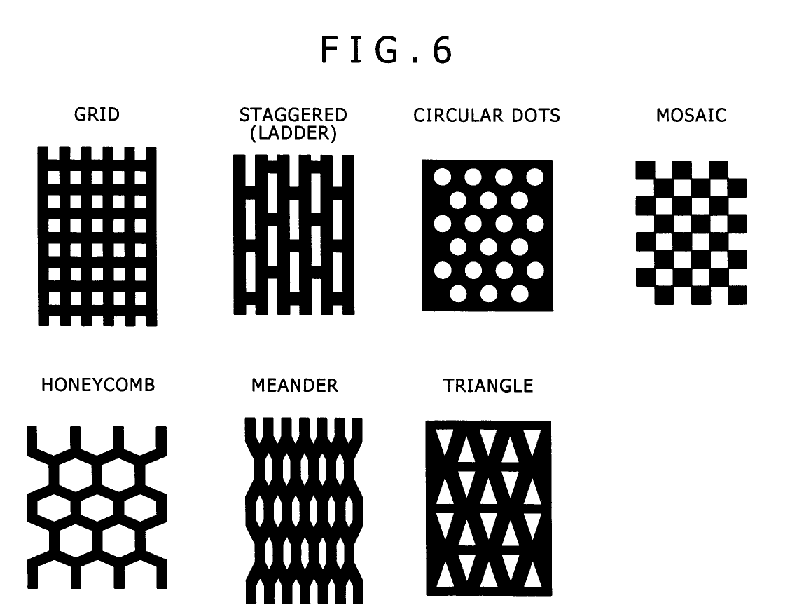

In the examples, the plan shape of a part surrounding a unit phosphor region 21 in the lattice-shaped barrier ribs 23 (which part corresponds to an inside contour line of a projection image of side surfaces of barrier ribs and is a kind of opening region 23B) is a rectangular shape (rectangle). However, as shown in FIG. 6, the plan shape of the part may be a square shape (shown in “MOSAIC” in FIG. 6), a circular shape (shown in “CIRCULAR DOTS” in FIG. 6), a hexagonal shape (shown in “HONEYCOMB” and “MEANDER” in FIG. 6), a triangular shape (shown in “TRIANGLE” in FIG. 6), an elliptical shape, an oval shape, a polygonal shape having five or more angles, a rounded triangular shape, a rounded rectangular shape, a rounded polygonal shape, or the like. Lattice-shaped barrier ribs are formed by arranging these plan shapes (the plan shape of the opening region) in the form of a two-dimensional matrix. This arrangement in the form of a two-dimensional matrix may be for example a grid-like arrangement or a staggered arrangement.

While description has been made of a form in which one electron emission part corresponds to only one opening portion in an electron emission element, it is possible to employ a form in which a plurality of electron emission parts correspond to one opening portion or a form in which one electron emission part corresponds to a plurality of opening portions, depending on the structure of the electron emission element. Alternatively, it is possible to employ a form in which a plurality of first opening parts are provided in the gate electrode, a plurality of second opening parts communicating with the plurality of first opening parts are provided in the insulating layer, and one or a plurality of electron emission parts are provided.

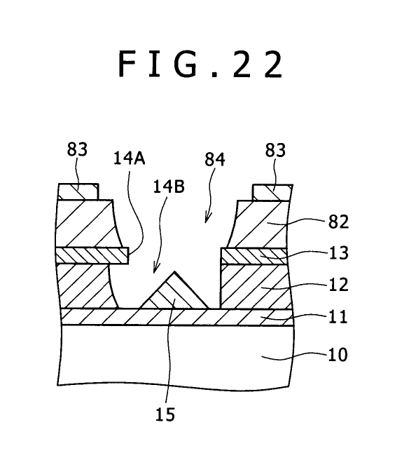

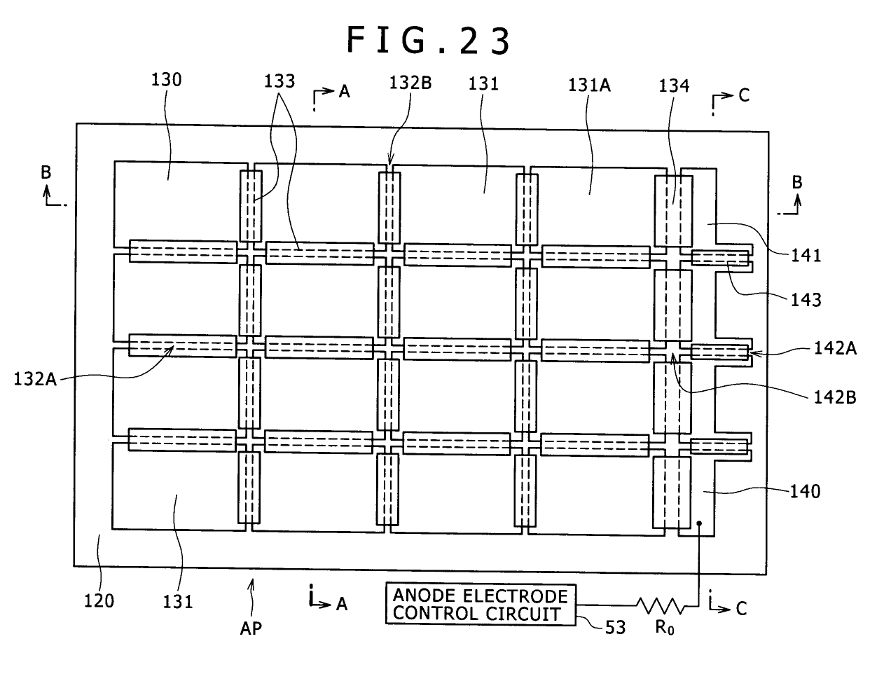

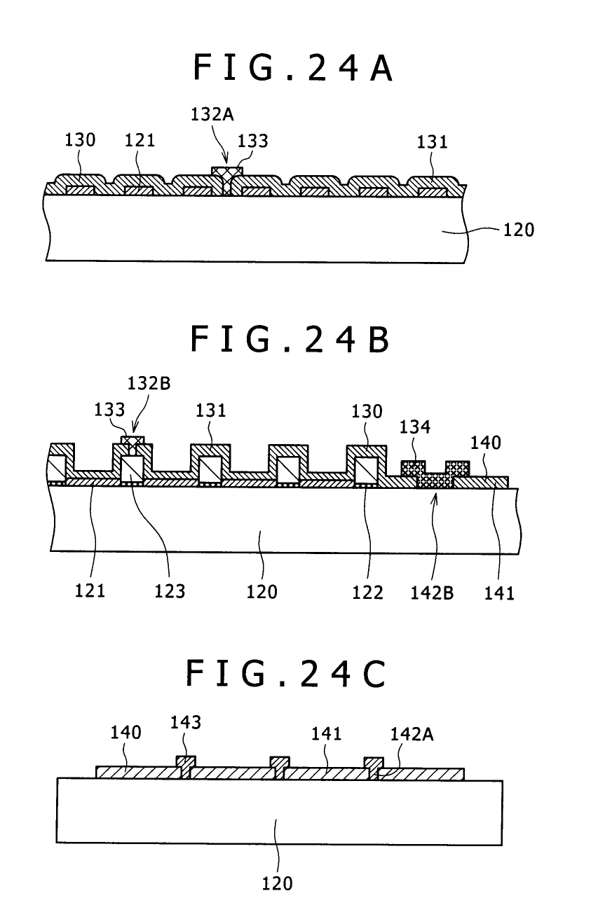

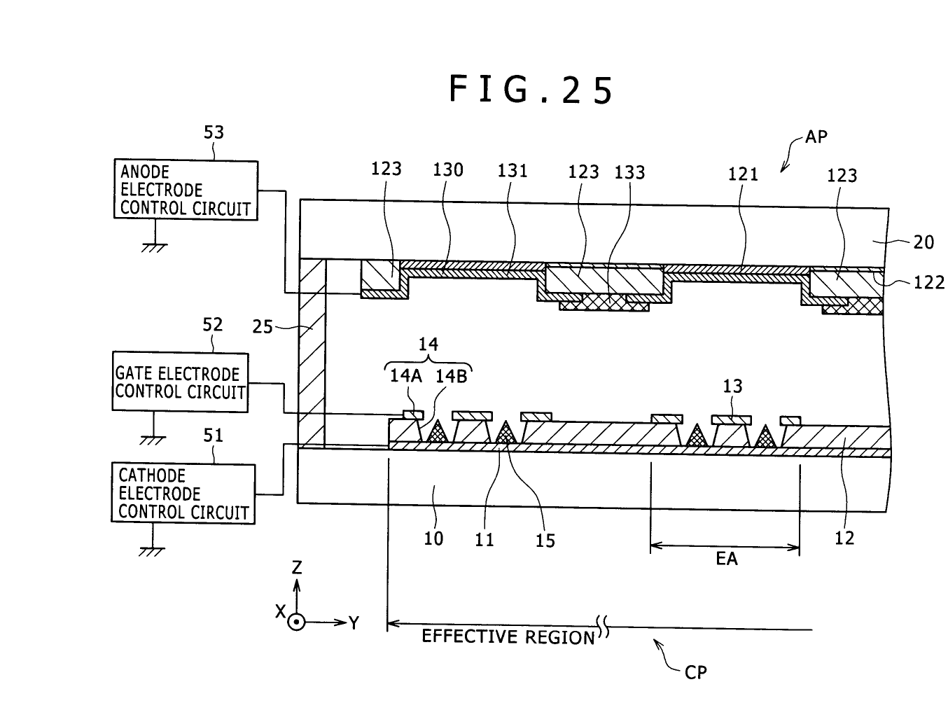

In the electron emission element, a second insulating layer 82 may be further provided on the gate electrode 13 and the insulating layer 12, and a converging electrode 83 may be formed on the second insulating layer 82. FIG. 22 is a schematic partial end view of a field emission element having such a structure. The second insulating layer 82 has a third opening portion 84 communicating with the first opening portion 14A. The converging electrode 83 may be formed as follows. For example, in [step A2], the second insulating layer 82 is formed after the gate electrode 13 in the form of a stripe is formed on the insulating layer 12; next, a patterned converging electrode 83 is formed on the second insulating layer 82; the third opening portion 84 is formed in the converging electrode 83 and the second insulating layer 82; and further the first opening portion 14A is formed in the gate electrode 13. Incidentally, depending on the patterning of the converging electrode, the converging electrode may be in the form of a set of converging electrode units each corresponding to one or a plurality of electron emission parts or one or a plurality of pixels, or may be in the form of one sheet of electrically conductive material covering the effective region. Incidentally, while FIG. 22 shows a Spindt-type field emission element, it is needless to say that the structure of FIG. 22 is also applicable to another type of field emission element.

The converging electrode may be not only formed by such a method but also made by another method of forming an insulating film composed of for example SiO2 on both surfaces of a metal sheet composed of for example a 42% Ni—Fe alloy having a thickness of a few ten μm and forming opening parts in regions corresponding to pixels by punching or etching. Then, the cathode panel, the metal sheet, and the anode panel are stacked. A frame is arranged in the peripheral part of the two panels. Heat treatment is carried out to bond the insulating film formed on one surface of the metal sheet to the insulating layer 12 and to bond the insulating layer formed on the other surface of the metal sheet to the anode panel, whereby these members are integrated. Thereafter evacuation and sealing is performed. Thereby the display device can be completed.

The electron emission part can also be formed of a field emission element commonly known as a surface conduction type field emission element. Surface conduction type field emission elements are made by forming pairs of counter electrodes in the form of a matrix on a support made of for example glass, the counter electrodes being composed of an electrically conductive material such as tin oxide (SnO₂), gold (Au), indium oxide (In₂O₃)/tin oxide (SnO₂), carbon, palladium oxide (PdO) or the like, and having a minute area, and one pair of counter electrodes being arranged at a predetermined interval (gap). A carbon thin film is formed so as to extend over the counter electrodes. A row-direction wiring or a column-direction wiring (first electrode) is connected to one of the pair of counter electrodes, and the column-direction wiring or the row-direction wiring (second electrode) is connected to the other of the pair of counter electrodes. When a voltage is applied to the pair of counter electrodes from the first electrode and the second electrode, an electric field is applied to the carbon thin films opposed to each other with a gap between the carbon thin films, so that electrons are emitted from the carbon thin films. Such electrons are allowed to collide with a phosphor region on the anode panel, whereby the phosphor region is excited to emit light. Thus, a desired image can be obtained. Alternatively, an electron emission source can be formed of a metal-insulator-metal element.

It should be understood by those skilled in the art that various modifications, combinations, sub-combinations and alterations may occur depending on design requirements and other factors insofar as they are within the scope of the appended claims or the equivalents thereof.

What is claimed is:

1. A method of manufacturing an anode panel for a flat-panel display device, said anode panel for said flat-panel display device including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, and (E) a resistor layer for electrically connecting adjacent anode electrode units to each other, said method comprising the steps of:
obtaining the anode electrode unit formed so as to extend from on each unit phosphor region to on the barrier ribs after forming the lattice-shaped barrier ribs on the substrate, then forming the unit phosphor regions on parts of the substrate which parts are surrounded by the barrier ribs, next forming the conductive material layer on an entire surface, and then removing parts of the conductive material layer which parts are situated on barrier rib top surfaces; and
forming the resistor layer for electrically connecting adjacent anode electrode units to each other after forming the lattice-shaped barrier ribs on the substrate, or after forming the unit phosphor regions on the parts of the substrate which parts are surrounded by the barrier ribs, or after removing the parts of the conductive material layer which parts are situated on the barrier rib top surfaces;
wherein a step of removing the parts of said conductive material layer which parts are situated on the barrier rib top surfaces includes a step of bonding a peeling member to the parts of the conductive material layer which parts are situated on the barrier rib top surfaces and then mechanically peeling off the peeling member.

2. The method of manufacturing an anode panel for a flat-panel display device as claimed in claim 1, further comprising a step of forming a resin layer on the barrier rib top surfaces and on the unit phosphor regions before forming the conductive material layer on the entire surface,
wherein the resin layer is removed by performing heat treatment after forming the conductive material layer on the entire surface or after removing the parts of the conductive material layer which parts are situated on the barrier rib top surfaces.

3. The method of manufacturing an anode panel for a flat-panel display device as claimed in claim 1,
wherein the peeling member includes one of a cohesive layer and an adhesive layer, and a retaining film for retaining one of the cohesive layer and the adhesive layer; and
a method of attaching the peeling member to the parts of the conductive material layer which parts are situated on the barrier rib top surfaces is a method of pressure-bonding one of the cohesive layer and the adhesive layer forming the peeling member to the parts of the conductive material layer which parts are situated on the barrier rib top surfaces.

4. The method of manufacturing an anode panel for a flat-panel display device as claimed in claim 3,
wherein a plan shape of a part of the barrier ribs which part surrounds a unit phosphor region is substantially a rectangle;
the resin layer is applied on the barrier rib top surfaces and the unit phosphor regions in parallel with a shorter side of the rectangle with a width narrower than a longer side of the rectangle; and
the peeling member is mechanically peeled off along a direction parallel with the longer side of the rectangle.

5. The method of manufacturing an anode panel for a flat-panel display device as claimed in claim 1,
wherein the anode panel further includes a feeding section having a projection-depression shape formed simultaneously with formation of the barrier ribs;
an anode electrode unit situated at an outermost peripheral part of the anode panel is connected to an anode electrode control circuit via the feeding section;
a feeding section conductive material layer is formed on an entire surface of the feeding section simultaneously with formation of the conductive material layer;
parts of the feeding section conductive material layer which parts are situated on feeding section projection parts are removed simultaneously with removal of the parts of the conductive material layer which parts are situated on the barrier rib top surfaces; and
a feeding section resistor layer for electrically connecting the feeding section conductive material layer situated in adjacent depression parts of the feeding section is formed on the feeding section projection parts.

6. The method of manufacturing an anode panel for a flat-panel display device as claimed in claim 1,
wherein one pixel is formed by a red light emitting unit phosphor region, a green light emitting unit phosphor region, and a blue light emitting unit phosphor region.

7. A method of manufacturing an anode panel for a flat-panel display device, said anode panel for said flat-panel display device including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, and (E) a resistor layer for electrically connecting adjacent anode electrode units to each other, said method comprising the steps of:
obtaining the anode electrode unit formed so as to extend from on each unit phosphor region to on the barrier ribs after forming the lattice-shaped barrier ribs on the substrate, then forming the unit phosphor regions on parts of the substrate which parts are surrounded by the barrier ribs, next forming the conductive material layer on an entire surface, and then removing parts of the conductive material layer which parts are situated on barrier rib top surfaces; and
forming the resistor layer for electrically connecting adjacent anode electrode units to each other after forming the lattice-shaped barrier ribs on the substrate, or after forming the unit phosphor regions on the parts of the substrate which parts are surrounded by the barrier ribs, or after removing the parts of the conductive material layer which parts are situated on the barrier rib top surfaces;
wherein a step of removing the parts of said conductive material layer which parts are situated on the barrier rib top surfaces includes a step of applying an etchant to the parts of the conductive material layer which parts are situated on the barrier rib top surfaces.

8. The method of manufacturing an anode panel for a flat-panel display device as claimed in claim 7, further comprising a step of forming a resin layer on the barrier rib top surfaces and on the unit phosphor regions before forming the conductive material layer on the entire surface,
wherein the resin layer is removed by performing heat treatment after forming the conductive material layer on the entire surface or after removing the parts of the conductive material layer which parts are situated on the barrier rib top surfaces.

9. The method of manufacturing an anode panel for a flat-panel display device as claimed in claim 7,
wherein the anode panel further includes a feeding section having a projection-depression shape formed simultaneously with formation of the barrier ribs;
an anode electrode unit situated at an outermost peripheral part of the anode panel is connected to an anode electrode control circuit via the feeding section;
a feeding section conductive material layer is formed on an entire surface of the feeding section simultaneously with formation of the conductive material layer;
parts of the feeding section conductive material layer which parts are situated on feeding section projection parts are removed simultaneously with removal of the parts of the conductive material layer which parts are situated on the barrier rib top surfaces; and
a feeding section resistor layer for electrically connecting the feeding section conductive material layer situated in adjacent depression parts of the feeding section is formed on the feeding section projection parts.

10. The method of manufacturing an anode panel for a flat-panel display device as claimed in claim 7,
wherein one pixel is formed by a red light emitting unit phosphor region, a green light emitting unit phosphor region, and a blue light emitting unit phosphor region.

11. A method of manufacturing a flat-panel display device, said flat-panel display device being formed by joining an anode panel and a cathode panel having a plurality of electron emission elements to each other at peripheral parts of the anode panel and the cathode panel, said anode panel including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, and (E) a resistor layer for electrically connecting adjacent anode electrode units to each other, said anode panel being manufactured by said method comprising the steps of:
obtaining the anode electrode unit formed so as to extend from on each unit phosphor region to on the barrier ribs after forming the lattice-shaped barrier ribs on the substrate, then forming the unit phosphor regions on parts of the substrate which parts are surrounded by the barrier ribs, next forming the conductive material layer on an entire surface, and then removing parts of the conductive material layer which parts are situated on barrier rib top surfaces; and
forming the resistor layer for electrically connecting adjacent anode electrode units to each other after forming the lattice-shaped barrier ribs on the substrate, or after forming the unit phosphor regions on the parts of the substrate which parts are surrounded by the barrier ribs, or after removing the parts of the conductive material layer which parts are situated on the barrier rib top surfaces;
wherein a step of removing the parts of the conductive material layer which parts are situated on the barrier rib top surfaces includes a step of bonding a peeling member to the parts of the conductive material layer which parts are situated on the barrier rib top surfaces and then mechanically peeling off the peeling member.

12. A method of manufacturing a flat-panel display device, said flat-panel display device being formed by joining an anode panel and a cathode panel having a plurality of electron emission elements to each other at peripheral parts of the anode panel and the cathode panel, said anode panel including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, and (E) a resistor layer for electrically connecting adjacent anode electrode units to each other, the anode panel being manufactured by said method comprising the steps of:
obtaining the anode electrode unit formed so as to extend from on each unit phosphor region to on the barrier ribs after forming the lattice-shaped barrier ribs on the substrate, then forming the unit phosphor regions on parts of the substrate which parts are surrounded by the barrier ribs, next forming the conductive material layer on an entire surface, and then removing parts of the conductive material layer which parts are situated on barrier rib top surfaces; and
forming the resistor layer for electrically connecting adjacent anode electrode units to each other after forming the lattice-shaped barrier ribs on the substrate, after forming the unit phosphor regions on the parts of the substrate which parts are surrounded by the barrier ribs, or after removing the parts of the conductive material layer which parts are situated on the barrier rib top surfaces;
wherein a step of removing the parts of said conductive material layer which parts are situated on the barrier rib top surfaces includes a step of applying an etchant to the parts of the conductive material layer which parts are situated on the barrier rib top surfaces.

13. A method of manufacturing an anode panel for a flat-panel display device, said anode panel for said flat-panel display device including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, (E) a resistor layer for electrically connecting adjacent anode electrode units to each other, and (F) a feeding section having a projection-depression shape for connecting an anode electrode unit situated at an outermost peripheral part of the anode panel to an anode electrode control circuit, said method comprising the steps of:
forming the feeding section having the projection-depression shape on the substrate, then forming a feeding section conductive material layer on an entire surface of the feeding section, and next removing parts of the feeding section conductive material layer which parts are situated on feeding section projection parts; and
forming a feeding section resistor layer for electrically connecting the feeding section conductive material layer situated in adjacent depression parts of the feeding section on the feeding section projection parts after forming the feeding section having the projection-depression shape on the substrate or after removing the parts of the feeding section conductive material layer which parts are situated on the feeding section projection parts.

14. The method of manufacturing an anode panel for a flat-panel display device as claimed in claim 13, further comprising a step of forming a resin layer on the feeding section projection parts before forming the feeding section conductive material layer on the entire surface of the feeding section,
wherein the resin layer is removed by performing heat treatment after forming the feeding section conductive material layer on the entire surface of the feeding section or after removing the parts of the feeding section conductive material layer which parts are situated on the feeding section projection parts.

15. The method of manufacturing an anode panel for a flat-panel display device as claimed in claim 14,
wherein a peeling member is attached to the parts of the feeding section conductive material layer which parts are situated on the feeding section projection parts, and then the peeling member is mechanically peeled off, whereby the parts of the feeding section conductive material layer which parts are situated on the feeding section projection parts are removed.

16. The method of manufacturing an anode panel for a flat-panel display device as claimed in claim 15,
wherein the peeling member includes one of a cohesive layer and an adhesive layer, and a retaining film for retaining one of the cohesive layer and the adhesive layer; and
a method of attaching the peeling member to the parts of the feeding section conductive material layer which parts are situated on the feeding section projection parts is a method of pressure-bonding one of the cohesive layer and the adhesive layer forming the peeling member to the parts of the feeding section conductive material layer which parts are situated on the feeding section projection parts.

17. The method of manufacturing an anode panel for a flat-panel display device as claimed in claim 14,
wherein the parts of the feeding section conductive material layer which parts are situated on the feeding section projection parts are removed by applying an etchant to the parts of the feeding section conductive material layer which parts are situated on the feeding section projection parts.

18. A method of manufacturing a flat-panel display device, said flat-panel display device being formed by joining an anode panel and a cathode panel having a plurality of electron emission elements to each other at peripheral parts of the anode panel and the cathode panel, said anode panel including (A) a substrate, (B) a plurality of unit phosphor regions formed on the substrate, (C) lattice-shaped barrier ribs surrounding each unit phosphor region, (D) an anode electrode unit made of a conductive material layer and formed so as to extend from on each unit phosphor region to on barrier ribs, (E) a resistor layer for electrically connecting adjacent anode electrode units to each other, and (F) a feeding section having a projection-depression shape for connecting an anode electrode unit situated at an outermost peripheral part of the anode panel to an anode electrode control circuit, the anode panel being manufactured by said method comprising the steps of:
forming the feeding section having the projection-depression shape on the substrate, then forming a feeding section conductive material layer on an entire surface of the feeding section, and next removing parts of the feeding section conductive material layer which parts are situated on feeding section projection parts; and
forming a feeding section resistor layer for electrically connecting the feeding section conductive material layer situated in adjacent depression parts of the feeding section on the feeding section projection parts after forming the feeding section having the projection-depression shape on the substrate or after removing the parts of the feeding section conductive material layer which parts are situated on the feeding section projection parts.
